(19) United States
(12) Patent Application Publication
(10) Pub. No.: US 2025/0265975 A1
(43) Pub. Date: Aug. 21, 2025

(54) DATA DRIVING CIRCUIT AND DISPLAY DEVICE

(71) Applicant: LG Display Co., Ltd., Seoul (KR)

(72) Inventors: Bonghwan KIM, Paju-si (KR); Wooho SONG, Paju-si (KR)

(73) Assignee: LG Display Co., Ltd., Seoul (KR)

(21) Appl. No.: 19/050,928

(22) Filed: Feb. 11, 2025

(30) Foreign Application Priority Data
Feb. 19, 2024 (KR) 10-2024-0023761
Jul. 31, 2024 (KR) 10-2024-0101653

(51) Int. Cl. G09G 3/32; G09G 3/3266; G09G 3/3291

(52) U.S. Cl. CPC G09G 3/32; G09G 3/3266; G09G 3/3291; G09G 2310/0267; G09G 2310/027; G09G 2310/0275; G09G 2310/08; G09G 2320/0223; G09G 2320/0233; G09G 2330/021

(57) ABSTRACT

A data driving circuit, a display device and a method are discussed, which are capable of reducing data settling time and preventing or reducing brightness fluctuation by providing a data voltage to which overdriving compensation is applied based on the comparison result of digital data voltages. The data driving circuit can include a latch circuit configured to store first digital data of an n-th subpixel connected to an n-th gate line according to a sampling signal, a line buffer configured to store second digital data of an n−1-th subpixel connected to an n−1-th gate line, and a data compensation circuit configured to compare the first digital data of the n-th subpixel with the second digital data of the n−1-th subpixel to update second digital data of the n-th subpixel in the line buffer.

### CROSS-REFERENCE TO RELATED APPLICATION

This application claims priority to Korean Patent Application No. 10-2024-0023761, filed on Feb. 19, 2024 in the Republic of Korea, and Korean Patent Application No. 10-2024-0101653, filed on Jul. 31, 2024 in the Republic of Korea, the entire contents of all these applications being hereby expressly incorporated by reference into the present application.

### BACKGROUND

### Field

Embodiments of the present disclosure relate to a data driving circuit and a display device, and more particularly, for example, without limitation, to a data driving circuit and a display device capable of being driven with high efficiency while reducing power consumption by reducing data settling time through data overdriving compensation and preventing or reducing the luminance variation depending on location.

### Discussion of the Related Art

As the information society develops, there is increasing a demand for display devices for displaying images, and there are being utilized various types of display devices such as liquid crystal display devices and organic light emitting display devices.

In a display device, there can occur the stretching of signal waveforms due to an increase in resistance capacitance (RC) delay according to an increase in the size and resolution of the display panel. In this case, there can be caused driving abnormalities such as an abnormal black expression or a black appearance, an increased stain level, or a color variation in the display area.

The description provided in the discussion of the related art section should not be assumed to be prior art merely because it is mentioned in or associated with that section. The discussion of the related art section can include information that describes one or more aspects of the subject technology, and the description in this section does not limit the disclosure.

### SUMMARY OF THE DISCLOSURE

Therefore, the inventors of the present disclosure have invented a method for preventing or minimizing image quality abnormalities in the display area due to an RC delay.

Embodiments of the present disclosure can provide a data driving circuit and a display device capable of being driven with high efficiency while reducing power consumption by reducing data settling time through data overdriving compensation and preventing or reducing the luminance variation depending on location.

Embodiments of the present disclosure can provide a data driving circuit and a display device capable of preventing or reducing the luminance variation depending on location by compensating for the data voltage, which changes depending on location due to the increase in an RC delay, to be settled to a target data voltage regardless of location.

Embodiments of the present disclosure can provide a data driving circuit and a display device capable of settling the target data voltage more efficiently by reducing the data settling time even in a single time (e.g., 1H Time) decreasing during a high frequency driving.

Embodiments of the present disclosure can provide a data driving circuit and a display device capable of reducing the data settling time more efficiently by optimizing the structure of the data driving circuit.

Embodiments of the present disclosure can provide a data driving circuit and a display device capable of reducing the size of a gate driving circuit by allowing at least two subpixels connected to different gate lines and adjacent to each other to share the same gate control signal line.

Embodiments of the present disclosure can provide a display device including a display panel on which a plurality of gate lines, a plurality of data lines, and a plurality of subpixels are disposed, a gate driving circuit for driving the plurality of gate lines, a data driving circuit for supplying a data voltage to the plurality of data lines, and a display controller for controlling the gate driving circuit and the data driving circuit, wherein the data driving circuit is configured to generate second digital data of an n-th subpixel on which an overdriving processing has been performed from first digital data of the n-th subpixel, based on a difference between the first digital data of the n-th subpixel connected to an n-th gate line among the plurality of gate lines and second digital data of an (n−1)-th subpixel connected to an (n−1)-th gate line among the plurality of gate lines, and supply the data voltage based on the second digital data of the n-th subpixel.

Embodiments of the present disclosure can provide a display device including a display panel including a first panel area and a second panel area, in which a plurality of gate lines, a plurality of data lines, and a plurality of subpixels are disposed respectively, a gate driving circuit for driving the plurality of gate lines, a first data driving circuit for supplying a data voltage to the plurality of data lines provided in the first panel area, and a second data driving circuit for supplying a data voltage to the plurality of data lines provided in the second panel area, wherein each of the first data driving circuit and the second data driving circuit is configured to generate second digital data of an n-th subpixel on which an overdriving processing has been performed from first digital data of the n-th subpixel, based on a difference between the first digital data of the n-th subpixel connected to an n-th gate line among the plurality of gate lines provided in each of the first panel area and the second panel area and second digital data of an (n−1)-th subpixel connected to an (n−1)-th gate line among the plurality of gate lines, and supply the data voltage based on the second digital data of the n-th subpixel.

Embodiments of the present disclosure can provide a data driving circuit including a first latch circuit for storing first digital data of an n-th subpixel connected to an n-th gate line among a plurality of gate lines disposed on a display panel according to a sampling signal, a line buffer for storing second digital data of an (n−1)-th subpixel connected to an (n−1)-th gate line among the plurality of gate lines, a data compensation circuit for comparing the first digital data of the n-th subpixel with the second digital data of the (n−1)-th subpixel to update second digital data of the n-th subpixel in the line buffer, a second latch circuit for receiving the second digital data of the n-th subpixel from the line buffer and outputting the second digital data of the n-th subpixel in response to a data timing control signal, wherein the data compensation circuit is configured to generate the second digital data of the n-th subpixel by applying an overdriving voltage to the first digital data of the n-th subpixel for an overdriving period of a length determined based on a comparison result between the first digital data of the n-th subpixel and the second digital data of the (n−1)-th subpixel.

According to example embodiments of the present disclosure, it is possible to provide a data driving circuit and a display device capable of being driven with high efficiency while reducing power consumption by reducing data settling time through data overdriving compensation and preventing or reducing the luminance variation depending on location.

According to example embodiments of the present disclosure, it is possible to provide a data driving circuit and a display device capable of preventing or reducing the luminance variation depending on location by compensating for the data voltage, which changes depending on location due to the increase in an RC delay, to be settled to a target data voltage regardless of location.

According to example embodiments of the present disclosure, it is possible to provide a data driving circuit and a display device capable of settling the target data voltage more efficiently by reducing the data settling time even in a single time (e.g., 1H Time) decreasing during a high frequency driving.

According to example embodiments of the present disclosure, it is possible to provide a data driving circuit and a display device capable of reducing the data settling time more efficiently by optimizing the structure of the data driving circuit.

According to example embodiments of the present disclosure, it is possible to provide a data driving circuit and a display device capable of reducing the size of a gate driving circuit by allowing at least two subpixels connected to different gate lines and adjacent to each other to share the same gate control signal line.

Purposes according to the present disclosure are not limited to the above-mentioned purpose. Other purposes and advantages according to the present disclosure that are not mentioned can be understood based on following descriptions, and can be more clearly understood based on embodiments according to the present disclosure. Further, it will be easily understood that the purposes and advantages according to the present disclosure can be realized using means shown in the claims or combinations thereof.

It is to be understood that both the foregoing general description and the following detailed description of the present disclosure are example and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a diagram for explaining a display device according to example embodiments of the present disclosure.

FIG. 2 illustrates an example of a subpixel circuit disposed in a display panel of a display device according to example embodiments of the present disclosure.

FIG. 3 illustrates another example of a subpixel circuit SP disposed in a display panel of a display device according to example embodiments of the present disclosure.

FIG. 4 illustrates change in the characteristics of a data voltage due to an RC delay in a display device according to example embodiments of the present disclosure.

FIG. 5A and FIG. 5B illustrate a data overdriving compensation process of a display device according to example embodiments of the present disclosure.

FIG. 6 illustrates a data driving circuit according to example embodiments of the present disclosure.

FIG. 7 illustrates a result of performing overdriving compensation in a display device according to example embodiments of the present disclosure.

FIG. 8 illustrates an implementation example of a display device according to example embodiments of the present disclosure.

FIG. 9 illustrates another implementation example of a display device according to example embodiments of the present disclosure.

FIG. 10 illustrates a gate driving circuit according to example embodiments of the present disclosure.

FIG. 11 illustrates an implementation example of a display panel according to example embodiments of the present disclosure.

FIG. 12 illustrates another implementation example of a display panel according to example embodiments of the present disclosure.

Throughout the drawings and the detailed description, unless otherwise described, the same drawing reference numerals should be understood to refer to the same elements, features, and structures. The relative size and depiction of these elements can be exaggerated for clarity, illustration, and convenience.

### DETAILED DESCRIPTION OF THE EMBODIMENTS

In the following description of examples or embodiments of the present disclosure, reference will be made to the accompanying drawings in which it is shown by way of illustration specific examples or embodiments that can be implemented, and in which the same reference numerals and signs can be used to designate the same or like components even when they are shown in different accompanying drawings from one another. Further, in the following description of examples or embodiments of the present disclosure, detailed descriptions of well-known functions and components incorporated herein will be omitted or briefly given when it is determined that the description can make the subject matter in some embodiments of the present disclosure rather unclear. The terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” can be used herein to describe elements of the present disclosure. Each of these terms is not used to define essence, order, sequence, or number of elements etc., but is used merely to distinguish the corresponding element from other elements. For example, a first element could be termed a second element, and, similarly, a second element could be termed a first element, without departing from the scope of the present disclosure.

When it is mentioned that a first element “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element can be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms can be used to describe non-consecutive or non-sequential processes or operations unless the term “directly” or “immediately” is used together.

In addition, when any dimensions, relative sizes etc. are mentioned, it should be considered that numerical values for an elements or features, or corresponding information (e.g., level, range, etc.) include a tolerance or error range that can be caused by various factors (e.g., process factors, internal or external impact, noise, etc.) even when a relevant description is not specified. Further, the term “can” fully encompasses all the meanings of the term “may”.

The term “at least one” should be understood as including any and all combinations of one or more of the associated listed items. For example, the meaning of “at least one of a first element, a second element, and a third element” compasses the combination of all three listed elements, combinations of any two of the three elements, as well as each individual element, the first element, the second element, or the third element.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning for example consistent with their meaning in the context of the relevant art and should not be interpreted in an idealized or overly formal sense unless expressly so defined herein. For example, the term “part” or “unit” can apply, for example, to a separate circuit or structure, an integrated circuit, a computational block of a circuit device, or any structure configured to perform a described function as should be understood to one of ordinary skill in the art.

The features of the various embodiments of the present disclosure can be partially or entirely combined with each other, and can be technically associated with each other or operate with each other. The embodiments can be implemented independently of each other and can be implemented together in an association relationship.

Hereinafter, it will be described various embodiments of the disclosure in detail with reference to the accompanying drawings. All the components of each display device according to all embodiments of the present disclosure are operatively coupled and configured. The scales of the components shown in the drawings have different scales from the actual ones for convenience of explanation, and thus are not limited to the scales shown in the drawings.

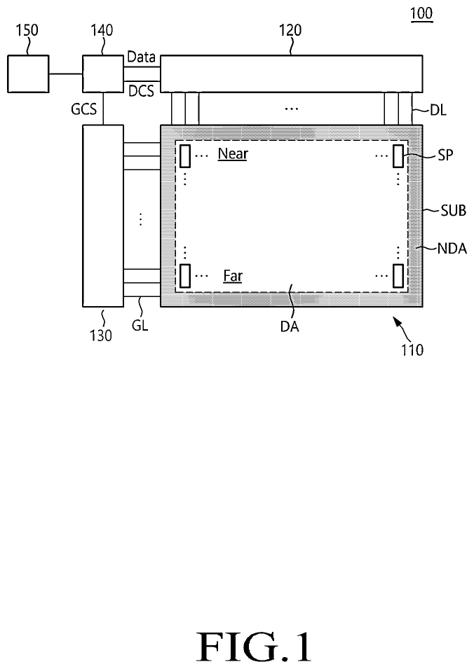

FIG. 1 is a diagram for explaining a display device 100 according to example embodiments of the present disclosure.

Referring to FIG. 1, the display device 100 according to example embodiments of the present disclosure can include a display panel 110 including a plurality of subpixels SP, and a driving circuit for driving the plurality of subpixels SP included in the display panel 110.

The driving circuit can include a data driving circuit 120 and a gate driving circuit 130, and can further include a display controller 140 for controlling the data driving circuit 120 and the gate driving circuit 130, and other circuit components.

The display panel 110 can include a substrate SUB, and various types of signal lines to drive the plurality of subpixels SP such as a plurality of data lines DL and a plurality of gate lines GL arranged on the substrate SUB. The plurality of data lines DL and the plurality of gate lines GL can be connected to a plurality of subpixels SP.

If the number of gate lines GL in the display panel 110 is N (where N is a positive integer), a first gate line, a second gate line, . . . , an (M−1)-th gate line, an M-th gate line, . . . , an (N−1)-th gate line and an N-th gate line (where M and N are positive integers satisfying the condition of N−1>M) can be sequentially disposed from aa area near the data driving circuit 120 to an area far from the data driving circuit 120.

The display panel 110 can include a display area DA where an image is displayed and a non-display area NDA where an image is not displayed. The plurality of subpixels SP for displaying an image can be disposed in the display area DA.

The non-display area NDA can be an area outside of the display area DA, and also be referred to as an edge area or a bezel area. All or a portion of the non-display area NDA can be an area visible from the front surface of the display device 100, or an area that is bent and invisible from the front surface of the display device 100 or an area that is covered by a case or housing of the display device 100.

In the display area DA of the display panel 110, the plurality of subpixels SP for displaying an image are disposed, and in the non-display area NDA of the display panel 110, the driving circuits 120, 130 and 140 can be electrically connected, or the driving circuits 120, 130 and 140 can be mounted, and a pad portion to which an integrated circuit or a printed circuit is connected can be disposed. However, the arrangement of the display panel 110 is not limited thereto.

The data driving circuit 120 can be a circuit for driving a plurality of data lines DL, and can supply data signals to the plurality of data lines DL.

The gate driving circuit 130 can be a circuit for driving a plurality of gate lines GL, and can supply a gate signal to the plurality of gate lines GL.

The display controller 140 can supply a data control signal DCS to the data driving circuit 120 to control the operation timing of the data driving circuit 120, and can supply a gate control signal GCS to the gate driving circuit 130 to control the operation timing of the gate driving circuit 130.

The display controller 140 can start scanning according to the timing implemented in each frame, convert the input image data input from the outside into a data signal format used by the data driving circuit 120, supply the converted image data Data to the data driving circuit 120, and control the data driving at an appropriate time according to the scan.

The display controller 140 can receive various timing signals including a vertical synchronization signal VSYNC, a horizontal synchronization signal HSYNC, an input data enable signal DE, and a clock signal CLK, along with the input image data, from the outside (e.g., the host system 150).

The display controller 140 can receive timing signals such as a vertical synchronization signal VSYNC, a horizontal synchronization signal HSYNC, an input data enable signal DE, and a clock signal CLK to control the data driving circuit 120 and the gate driving circuit 130, generate various control signals DCS and GCS, and output the control signals to the data driving circuit 120 and the gate driving circuit 130.

For example, the display controller 140 can output various gate control signals GCS including a gate start pulse GSP, a gate shift clock GSC, and a gate output enable signal GOE to control the gate driving circuit 130.

In addition, the display controller 140 can output various data control signals DCS including a source start pulse SSP, a source sampling clock SSC, a source output enable signal SOE to control the data driving circuit 120.

However, the embodiments of the present disclosure are not limited thereto, and the data driving circuit 120 can receive a data control signal DCS including a timing control clock related to a source output enable signal SOE from the display controller 140, and directly generate the source output enable signal SOE.

The display controller 140 can be implemented as a separate component from the data driving circuit 120, or can be implemented as an integrated circuit by being integrated with the data driving circuit 120.

The data driving circuit 120 can receive image data Data from the display controller 140 and supply data voltages to a plurality of data lines DL, thereby driving a plurality of data lines DL. Here, the data driving circuit 120 can also be referred to as a source driving circuit.

The data driving circuit 120 can include at least one source driver integrated circuit SDIC.

Each source driver integrated circuit can include a shift register, a latch circuit, a digital to analog converter DAC, and an output buffer, and the like. Each source driver integrated circuit can further include an analog to digital converter ADC, depending on the case.

For example, each source driver integrated circuit can be connected to the display panel 110 in a tape-automated-bonding (TAB) manner, can be directly disposed on the display panel 110, can be connected to a bonding pad of the display panel 110 in a chip-on-glass (COG) or chip-on-panel (COP) manner, or can be implemented in a chip-on-film (COF) manner and connected to the display panel 110. In this case, each source driver integrated circuit SDIC can be mounted on a film connected to the display panel 110, and can be electrically connected to the display panel 110 through wires on the film.

The gate driving circuit 130 can output a gate signal of a turn-on voltage level or a gate signal of a turn-off voltage level according to the control of the display controller 140. The gate driving circuit 130 can sequentially drive a plurality of gate lines GL by sequentially supplying gate signals of a turn-on voltage level to a plurality of gate lines GL.

The gate driving circuit 130 can be connected to the display panel 110 in a tape-automated-bonding (TAB) manner, can be connected to a conductive pad such as a bonding pad of the display panel 110 in a chip-on-glass (COG) or chip-on-panel (COP) manner, or can be connected to the display panel 110 in a chip-on-film (COF) manner. Alternatively, the gate driving circuit 130 can be formed in a non-display area NDA of the display panel 110 as a gate-in-panel (GIP) type. The gate driving circuit 130 can be disposed on the substrate SUB or connected to the substrate SUB. For example, the gate driving circuit 130 can be disposed in the non-display area NDA of the substrate SUB if it is a GIP type. Alternatively, the gate driving circuit 130 can be disposed in the display area DA of the display panel 110. The gate driving circuit 130 can be connected to the substrate SUB if it is a chip-on-glass (COG) type, a chip-on-film (COF) type, or the like.

The first substrate SUB can include glass, plastic, or a flexible polymer film. For example, the flexible polymer film can be made of any one of polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, and polystyrene (PS), which is only an example and is not necessarily limited thereto.

Meanwhile, at least one of the data driving circuit 120 and the gate driving circuit 130 can be disposed in the display area DA of the display panel 110. For example, at least one of the data driving circuit 120 and the gate driving circuit 130 can be disposed so as not to overlap with the subpixels SP, or can be disposed so as to partially or completely overlap with the subpixels SP.

If a gate line GL selected by the gate driving circuit 130 is driven, the data driving circuit 120 can convert the image data Data received from the display controller 140 into an analog data voltage and supply the converted image data to a plurality of data lines DL.

The data driving circuit 120 can be connected to, but not limited to, one side (e.g., the upper side or the lower side) of the display panel 110. Depending on the driving method and the panel design method, the data driving circuit 120 can be connected to, but not limited to, both sides (e.g., the upper side and the lower side) of the display panel 110, or can be connected to two or more of the four sides (e.g., the upper side, the lower side, the left side, and the right side) of the display panel 110.

The data driving circuit 120 according to the embodiments of the present disclosure can reduce the data settling time through data overdriving compensation for the data voltage, thereby minimizing or reducing the luminance variation according to the position within the display area DA.

Hereinafter, for convenience of explanation, at least one subpixel to which the data voltage has been transferred at the previous timing through the control of the data driving circuit 120 and the gate driving circuit 130 is described as the (n−1)-th subpixel connected to the (n−1)-th gate line, and at least one subpixel to which the data voltage will be transferred at the current timing (i.e., the timing immediately following the previous timing) through the control of the data driving circuit 120 and the gate driving circuit 130 is described as the n-th subpixel connected to the n-th gate line. Here, n can be a positive number such as a positive integer.

For example, a distance between the data driving circuit 120 and the (n−1)-th subpixel can be shorter than a distance between the data driving circuit 120 and the n-th subpixel.

For example, the (n−1)-th subpixel can be a subpixel located closer to the data driving circuit 120 than the n-th subpixel.

The data driving circuit 120 can generate second digital data of the n-th subpixel, which has been performed the overdriving process from the first digital data of the n-th subpixel, based on the difference between the first digital data of the n-th subpixel and the second digital data of the (n−1)-th subpixel, and supply a data voltage based on the second digital data of the n-th subpixel.

For example, the data driving circuit 120 can be configured to generate second digital data of an n-th subpixel on which an overdriving processing has been performed from first digital data of the n-th subpixel, based on a difference between the first digital data of the n-th subpixel connected to an n-th gate line among the plurality of gate lines and second digital data of an (n−1)-th subpixel connected to an (n−1)-th gate line among the plurality of gate lines, and supply the data voltage based on the second digital data of the n-th subpixel.

The data voltage, which is an analog voltage for the second digital data of the n-th subpixel, can be output from the data driving circuit 120 during the data writing period.

For example, the data voltage can be a voltage having an overdriving voltage during an overdriving period within a data writing period, and can be an analog voltage for the first digital data of the n-th subpixel during a period after the overdriving period within the data writing period.

For example, the first digital data can be data output from a first latch circuit provided in the data driving circuit 120, and the second digital data can be data output from a second latch circuit provided in the data driving circuit 120.

In addition, the overdriving period can increase as the distance between the data driving circuit 120 and the n-th subpixel increases, and the level of the overdriving voltage can increase as the distance between the data driving circuit 120 and the n-th subpixel increases.

For example, in order to improve the phenomenon in which the data settling time increases due to the increase in the size of the resistance (R) and capacitor (C) of the data line DL (i.e., the increase in RC delay), the data driving circuit 120 according to the embodiments of the present disclosure can minimize or reduce the luminance variation or the brightness fluctuations by comparing data previously input to the data line with data to be currently input to the data line, and performing data overdriving compensation based on the comparison result so that the final settled data voltage is controlled to be almost the same as the target data voltage, without being limited thereto.

For example, the data driving circuit 120 can compensate for the increase in RC delay in the n-th subpixel more accurately through a process of comparing the digital data values of two subpixels, i.e., the (n−1)-th subpixel and the th subpixel, which are connected to the same data line DL and are adjacent to each other.

The gate driving circuit 130 can be located in, and/or electrically connected to, but not limited to, one side (e.g., the left side or the right side) of the display panel 110, without being limited thereto. Depending on the gate driving method and the panel design method, the gate driving circuit 130 can be located in, and/or electrically connected to both sides (e.g., the left side and the right side) of the display panel 110, or can be connected to two or more of the four sides (e.g., the upper side, the lower side, the left side, and the right side) of the display panel 110. The display controller 140 can be a timing controller used in related display technology, or can be a control device capable of performing other control functions including a timing controller, can be a control device other than a timing controller, or can be a circuit within a control device. The display controller 140 can be implemented with various circuits or electronic components such as an integrate circuit (IC), an FPGA (Field Programmable Gate Array), an ASIC (Application Specific Integrated Circuit), or a processor, and/or the like, without being limited thereto.

The display controller 140 can be mounted on a printed circuit board, a flexible printed circuit, etc., and can be electrically connected to the data driving circuit 120 and the gate driving circuit 130 through the printed circuit board, the flexible printed circuit, etc.

The display controller 140 can transmit and receive signals with the data driving circuit 120 according to one or more predefined interfaces. Here, for example, the interface can include an Low Voltage Differential Signaling (LVDS) interface, an Embedded Clock Point to Point Interface EPI), an a Serial Peripheral Interface (SPI), etc. Similarly, the display controller 140 can transmit signals to, and receive signals from, the gate driving circuit 130 via one or more predefined interfaces.

The display controller 140 can include one or more memory media such as registers.

The display device 100 according to the embodiments of the present disclosure can be a display including a backlight unit such as a liquid crystal display device (LCD), a plasma display device (PDP), a field emission display device (FED), or the like, or can be a self-luminous display device in which light is emitted from the display panel 110 itself, such as an organic light emitting display, a quantum dot display, an inorganic light emitting display, etc.

If the display device 100 is an organic light emitting display device, each subpixel SP can include an organic light emitting diode (OLED) that emits light by itself as a light emitting device.

If the display device 100 is a quantum dot (QD) display device, each subpixel SP can include a light emitting device made of a quantum dot, which is a semiconductor crystal emitting light by itself.

If the display device 100 is an inorganic light emitting display device, each subpixel SP can include an inorganic light emitting device, which emits light by itself and is made based on an inorganic material, as a light emitting device. For example, an inorganic light emitting device can be also referred to as a micro light emitting diode, and an inorganic light emitting display device can be also referred to as a micro LED display device.

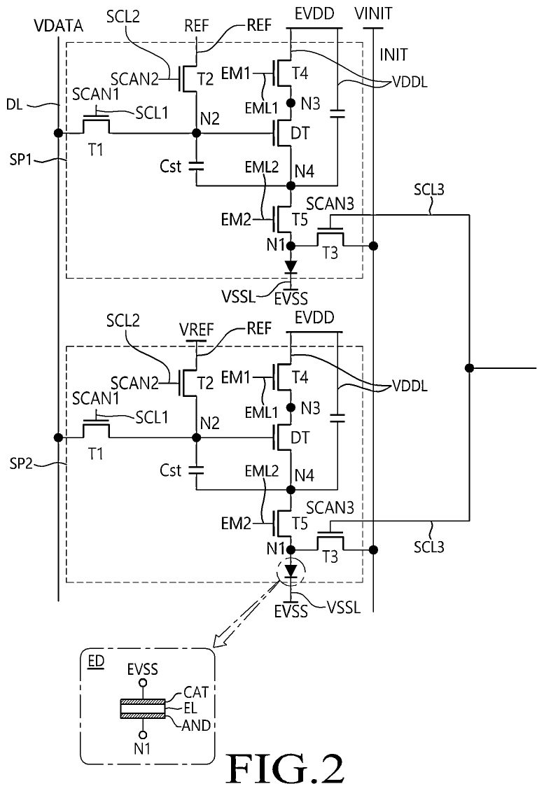

FIG. 2 illustrates an example of a subpixel circuit of the subpixels SP1 and SP2 disposed in a display panel 110 according to example embodiments of the present disclosure.

Referring to FIG. 2, each of the plurality of subpixels SP disposed on the display panel 110 according to the embodiments of the present disclosure can include a subpixel circuit including a light emitting device ED and a driving transistor DT configured to drive the light emitting device ED.

For example, the display panel 110 can include a first subpixel circuit SP1 of the n-th subpixel connected to the n-th gate line, and a second subpixel SP2 circuit of the n-th subpixel connected to the n-th gate line. In this case, the (n−1)-th subpixel circuit SP1 and the n-th subpixel circuit SP2 can be configured with the same or similar to structure.

The subpixel circuit SP1 and SP2 can further include one or more transistors in addition to the driving transistor DT. The subpixel circuit SP1 and SP2 can include one or more oxide semiconductor transistors (e.g., oxide TFTs).

The subpixel circuit SP1 and SP2 can include the driving transistor DT and first to fifth transistors T1-T5. For example, the subpixel circuit SP1 and SP2 can have a 6T (Transistor)-2C (Capacitor) structure including six transistors (e.g., DT, T1-T5) and two capacitors, respectively.

However, the subpixel circuit SP1 and SP2 according to the embodiments of the present disclosure is not limited thereto, and can be applied to various structures such as a 3T-1C structure and an 8T-2C structure.

For example, the display device 100 according to the embodiments of the present disclosure can be applied to various sizes of display panels 110 regardless of the size of the display panel 110 (e.g., large or small display panel, etc.).

The light emitting device ED can include an anode electrode AND and a cathode electrode CAT, and can include an emission layer EL located between the anode electrode AND and the cathode electrode CAT.

The emission layer EL can include an organic material layer. For example, the emission layer EL can include one or more of a hole injection layer (HIL), a hole transmitting layer (HTL), an electron transmitting layer (ETL) and an electron injection layer (EIL), but the present disclosure is not limited thereto.

One of the anode electrode AND and the cathode electrode CAT can be a pixel electrode connected to a transistor such as a driving transistor DT, and the other can be a common electrode to which a common voltage is applied. Here, the pixel electrode can be an electrode arranged for each subpixel SP, and the common electrode can be an electrode commonly arranged for all subpixels SP. For example, the common voltage can be a high-level common voltage, a high-potential voltage EVDD, or a low-level common voltage, a low-potential voltage EVSS. Here, the high-potential voltage EVDD can be a voltage applied through a high-potential voltage line VDDL, and can be also referred to as a driving voltage. In addition, the low-potential voltage EVSS can be a voltage applied through a low-potential voltage line VSSL, and can be also referred to as a base voltage.

According to the example of FIG. 2, the anode electrode AND can be a pixel electrode connected to a transistor such as a driving transistor DT, and the cathode electrode CAT can be a common electrode to which a low-potential voltage EVSS is applied.

For example, the light emitting device ED can be an organic light emitting diode (OLED), an inorganic-based light emitting diode (LED), or a quantum dot light emitting device which is a semiconductor crystal emitting light by itself, without being limited thereto. Referring to FIG. 2, the subpixel circuit SP1 and SP2 can include a second node N2, a third node N3, a fourth node N4.

The second node N2 can be a gate node of the driving transistor DT, and can be electrically connected to the source node or drain node of each of the first transistor T1 and the second transistor T2.

The third node N3 can be a drain node or a source node of the driving transistor DT, and can be electrically connected to the source node or drain node of the fourth transistor T4.

The fourth node N4 can be a source node or a drain node of the driving transistor DT, and can be electrically connected to the drain node or source node of the fifth transistor T5.

Meanwhile, the subpixel circuit SP1 and SP2 can further include a first node N1, and the first node N1 can be electrically connected to the source node or the drain node of each of the third transistor T3 and the fifth transistor T5, and can also be electrically connected to the anode electrode AND of the light emitting device ED.

The first transistor T1 can be connected between the data line DL to which the data voltage VDATA is applied and the second node N2, the second transistor T2 can be connected between reference voltage line REF and the second node N2, the fourth transistor T4 can be connected between the high-potential voltage line VDDL to which a high-potential voltage EVDD is applied and the third node N3, and the fifth transistor T5 can be connected between the fourth node N4 and the low-potential voltage line VSSL to which a low-potential voltage line VSSL is applied, the driving transistor DT can be connected between the third node N3 and the fourth node N4.

In addition, a storage capacitor Cst can be provided between the second node N2 and the fourth node N4, and an additional capacitor can also be provided between the fourth node N4 and the high-potential voltage line VDDL.

The first transistor T1 can be controlled by a first scan signal SCAN1, which is a type of gate signal, applied through the first scan line SCL1, and can be connected between the second node N2 and the data line DL. For example, the first transistor T1 can be turned on or off according to the first scan signal SCAN1 supplied from a first scan signal line, which is a type of gate line GL, to control the connection between the data line DL and the second node N2.

The first transistor T1 can be turned on by the first scan signal SCAN1 having the turn-on level voltage, and transmit the data voltage VDATA supplied from the data line DL to the second node N2.

Here, if the first transistor T1 is an N-type transistor, the turn-on level voltage of the first transistor T1 can be a high level voltage. If the first transistor T1 is a P-type transistor, the turn-on level voltage of the first transistor T1 can be a low level voltage.

For example, a second subpixel circuit SP2 corresponding to the n-th subpixel can receive a data voltage VDATA corresponding to the second digital data of the n-th subpixel from the data driving circuit 120 at the timing when the first transistor T1 of the second subpixel circuit SP2 is turned on.

The second transistor T2 can be controlled by a second scan signal SCAN2, which is a type of gate signal, and can be connected between the second node N2 and a reference voltage line REF. For example, the second transistor T2 can be turned on or off according to the second scan signal SCAN2 applied through a second scan line SCL2 as a type of gate line GL, thereby controlling the connection between the reference voltage line REF and the second node N2.

The second transistor T2 can be turned on by the second scan signal SCAN2 having the turn-on level voltage, and transmit the reference voltage VREF supplied from the reference voltage line REF to the second node N2.

Here, if the second transistor T2 is an N-type transistor, the turn-on level voltage of the second scan signal SCAN2 can be a high level voltage. If the second transistor T2 is a P-type transistor, the turn-on level voltage of the second scan signal SCAN2 can be a low level voltage.

In addition, the reference voltage line REF can be a line to which a reference voltage VREF is supplied, and the reference voltage VREF can be a common voltage.

The third transistor T3 can be controlled by a third scan signal SCAN3, which is a type of gate signal and applied through a third scan line SCL3, and can be connected between the first node N1 and an initialization line INIT. For example, the third transistor T3 can be turned on or off according to the third scan signal SCAN3 as a type of gate signal, and can control the connection between the first node N1 and the initialization line INIT.

The third transistor T3 can be turned on by the third scan signal SCAN3 having a turn-on level voltage, and can transmit an initialization voltage VINIT supplied from the initialization line INIT to the first node N1.

Here, if the third transistor T3 is an N-type transistor, the turn-on level voltage of the third scan signal SCAN3 can be a high level voltage. If the third transistor T3 is a P-type transistor, the turn-on level voltage of the third scan signal SCAN3 can be a low level voltage.

The fourth transistor T4 can be controlled by a first emission control signal EM1, which is a type of gate signal and is applied through a first emission control line EML1, and can be connected between the third node N3 and the high-potential voltage line VDDL. For example, the fourth transistor T4 can be turned on or off according to the first emission control signal EM1 supplied from the first emission control line EML1, which is a type of gate line GL, to control the connection between the third node N3 and the high-potential voltage line VDDL.

The fourth transistor T4 can be turned on by the first emission control signal EM1 having a turn-on level voltage, and can transmit the high-potential voltage EVDD applied through the high-potential voltage line VDDL to the third node N3.

Here, if the fourth transistor T4 is an N-type transistor, the turn-on level voltage of the first emission control signal EM1 can be a high level voltage. If the fourth transistor T4 is a P-type transistor, the turn-on level voltage of the first emission control signal EM1 can be a low level voltage.

For example, if the fourth transistor T4 is an N-type transistor, the fourth transistor T4 can be turned on by the first emission control signal EM1 having a high level voltage, and can transmit the high-potential voltage EVDD applied through the high-potential voltage line VDDL to the third node N3.

Further, if fourth transistor T4 is a P-type transistor, the fourth transistor T4 can be turned on by the first emission control signal EM1 having a low level voltage, and can transmit the high-potential voltage EVDD applied through the high-potential voltage line VDDL to the third node N3.

The fifth transistor T5 can be controlled by a second emission control signal EM2, which is a type of gate signal, applied through a second emission control line EML2, and can be connected between the fourth node N4 and the first node N1. For example, the fifth transistor T5 can be turned on or off according to the second emission control signal EM2 applied through the second emission control line EML2, which is a type of gate line GL, thereby controlling the connection between the fourth node N4 and the first node N1.

The fifth transistor T5 can be turned on by the second emission control signal EM2 having a turn-on level voltage, and can transmit the voltage of the fourth node N4 to the first node N1.

Here, if the fifth transistor T5 is an N-type transistor, the turn-on level voltage of the second emission control signal EM2 can be a high level voltage. If the fifth transistor T5 is a P-type transistor, the turn-on level voltage of the second emission control signal EM2 can be a low level voltage.

According to the example of FIG. 2, the third transistor T3 provided in the first subpixel circuit SP1 corresponding to the (n−1)-th subpixel and the third transistor T3 provided in the second subpixel circuit SP2 corresponding to the n-th subpixel can be connected to the same gate control signal line, i.e., the third scan line SCL3, and can receive the third scan signal SCAN3.

For example, the third transistor T3 provided in the first subpixel circuit SP1 and the third transistor T3 provided in the second subpixel circuit SP2 can be turned on or off based on the third scan signal SCAN3 applied through the same gate control signal line, i.e., the third scan line SCL3.

However, the embodiments of the present disclosure are not limited thereto, and the first subpixel circuit SP1 and the second subpixel circuit SP2 may not share the third scan line SCL3, or other transistors provided in the first subpixel circuit SP1 and the second subpixel circuit SP2 can share the gate control signal line with each other.

For example, the first subpixel circuit SP1 and the second subpixel circuit SP2 can share at least one gate control signal line among the second scan line SCL2, the first emission control line EML1, and the second emission control line EML2.

In the example of FIG. 2, the driving transistor DT and the first to fifth transistors T1-T5 are all N-type transistors, but the embodiments of the present disclosure are not limited thereto, and alternatively, at least one of the driving transistor DT and the first to fifth transistors T1-T5 can be a P-type transistor, and the others of the driving transistor DT and the first to fifth transistors T1-T5 can be the N-type transistors.

The N-type transistor can be formed as an oxide transistor formed using a semiconductor oxide (for example, a transistor having a channel formed from a semiconductor oxide such as indium, gallium, zinc oxide, or IGZO), without being limited thereto. The P-type transistor can be a silicon transistor formed from a semiconductor such as silicon (for example, a transistor having a polysilicon channel formed using a low-temperature process referred to as LTPS or low-temperature polysilicon), without being limited thereto.

An oxide transistor can have a characteristic of relatively lower leakage current than a silicon transistor. Accordingly, there can be relatively advantageous to implement a low refresh frame rate.

Meanwhile, a storage capacitor Cst can be connected between the second node N2 and the fourth node N4, and an amount of charge corresponding to a voltage difference between the two terminals of the storage capacitor Cst can be charged. In addition, the storage capacitor Cst can serve to maintain the voltage difference between the two terminals for a set frame time. Accordingly, the corresponding subpixel SP can emit light for a set frame time.

The storage capacitor Cst can be an external capacitor intentionally designed outside the driving transistor DT, rather than a parasitic capacitor (e.g., Cgs, Cgd) existing between the gate node and the source node (or drain node) of the driving transistor DT.

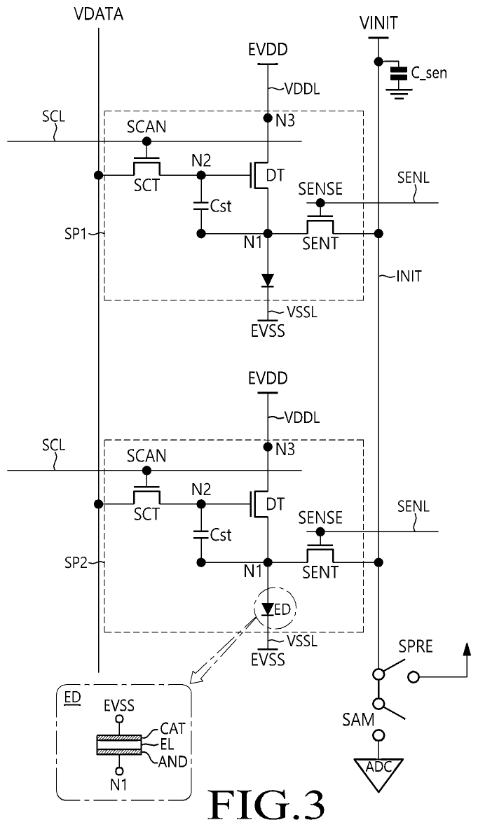

FIG. 3 illustrates another example of a subpixel circuit SP1 and SP2 disposed in a display panel 110 according to example embodiments of the present disclosure.

Referring to FIG. 3, each of the plurality of subpixels SP arranged on the display panel 110 according to the embodiments of the present disclosure can include a subpixel circuit having a light emitting device ED and a driving transistor DT configured to drive the light emitting device ED.

For example, the display panel 110 can include a first subpixel circuit SP1 of the (n−1)-th subpixel connected to the (n−1)-th gate line, and a second subpixel circuit SP2 of the n-th subpixel connected to the n-th gate line. In this case, the (n−1)-th subpixel circuit SP1 and the n-th subpixel circuit SP2 can be configured with the same or similar structure.

In addition to the driving transistor DT, the subpixel SP circuit can include one or more transistors such as a scan transistor SCT, a sensing transistor SENT, and a storage capacitor Cst. For example, the subpixel SP circuit can have a 3T (Transistor)-1C (Capacitor) structure including three transistors (e.g., DT, SCT, SENT) and one capacitor, respectively.

The light emitting device ED can include an anode electrode AND and a cathode electrode CAT, and an emission layer EL positioned between the anode electrode AND and the cathode electrode CAT.

The emission layer EL can include an organic material layer. For example, the emission layer EL can include one or more of a hole injection layer (HIL), a hole transmitting layer (HTL), an electron transmitting layer (ETL) and an electron injection layer (EIL), but the present disclosure is not limited thereto.

The anode electrode AND can be a pixel electrode involved in the formation of the light emitting device ED of each subpixel SP, and can be electrically connected to the first node N1. The cathode electrode CE can be a common electrode involved in the formation of the light emitting device of all subpixels SP, and can be connected to a low-potential voltage line VSSL to which a low-potential voltage EVSS can be applied.

The light emitting device ED can be electrically connected to the first node N1 and a low-potential voltage line VSSL supplying a low-potential voltage EVSS.

For example, the light emitting device ED can be an organic light emitting diode (OLED), an inorganic-based light emitting diode (LED), or a quantum dot light emitting device which is a semiconductor crystal emitting light by itself, without being limited thereto.

The driving transistor DT can drive the light emitting device ED by controlling the current flowing to the light emitting device ED.

For example, the driving transistor DT can be a transistor for driving the light emitting device ED, and can include a first node N1, a second node N2, and a third node N3.

The first node N1 can be the source or drain node of the driving transistor DT, and can be electrically connected to the anode electrode AE of the light emitting device ED. The second node N2 can be the gate node of the driving transistor DT, and can be electrically connected to the source or drain node of the scan transistor SCT. The third node N3 can be a drain node or a source node of the driving transistor DT, and can be electrically connected to the high-potential voltage line VDDL to which the high-potential voltage EVDD is applied.

The scan transistor SCT can transfer the data voltage VDATA applied through the data line DL to the second node N2 as the gate node of the driving transistor DT. The storage capacitor Cst can be configured to maintain the voltage for a predetermined period of time.

The scan transistor SCT can switch the connection between the data line DL and the second node N2 of the driving transistor DT. The scan transistor SCT can be turned on or off according to a scan signal SCAN supplied from a scan line SCL, which is a type of gate line GL, to control the connection between the second node N2 of the driving transistor DT and a corresponding data line DL among a plurality of data lines DL.

Here, if the scan transistor SCT is an N-type transistor, the turn-on level voltage of the scan signal SCAN can be a high level voltage. If the scan transistor SCT is a P-type transistor, the turn-on level voltage of the scan signal SCAN can be a low level voltage.

For example, if the scan transistor SCT is an N-type transistor, the scan transistor SCT can be turned on by the scan signal SCAN having a high level voltage, and can transmit the data voltage VDATA to the second node N2 of the driving transistor DT.

For example, the scan transistor SCT of the first subpixel circuit SP1 can be connected to a scan line SCL corresponding to the (n−1)-th gate line, and the scan transistor SCT of the second subpixel circuit SP2 can be connected to the scan line SCL corresponding to the n-th gate line.

The sensing transistor SENT can switch the connection between the initialization line INIT and the first node N1 of the driving transistor DT. The sensing transistor SENT can be turned on or off according to a sensing gate signal SENSE supplied from the sensing gate line SENL, which is a type of gate line GL, to control the connection between the first node N1 of the driving transistor DT and the initialization line INIT.

Here, if the sensing transistor SENT is an N-type transistor, the turn-on level voltage of the sensing gate signal SENSE can be a high level voltage. If the sensing transistor SENT is a P-type transistor, the turn-on level voltage of the sensing gate signal SENSE can be a low level voltage.

For example, if the sensing transistor SENT is an N-type transistor, the sensing transistor SENT can be turned on by the sensing gate signal SENSE having a high level voltage, and can connect the first node N1 of the driving transistor DT with the initialization line INIT.

For example, the sensing transistor SENT of the first subpixel circuit SP1 can be connected to the sensing gate line SENL corresponding to the (n−1)-th gate line, and the sensing transistor SENT of the second subpixel circuit SP2 can be connected to the sensing gate line SENL corresponding to the n-th gate line. The scan line SCL and the sensing gate line SENL can be different gate lines GL. In this case, the scan signal SCAN and the sensing gate signal SENSE can be separate gate signals, and the on-off timing of the scan transistor SCT in one subpixel SP and the on-off timing of the sensing transistor SENT can be independent. For example, the on-off timing of the scan transistor SCT in one subpixel SP and the on-off timing of the sensing transistor SENT can be the same or different.

Alternatively, the scan line SCL and the sensing gate line SENL can be the same gate line GL. For example, the gate node of the scan transistor SCT and the gate node of the sensing transistor SENT in one subpixel SP can be connected to one gate line GL. In this case, the scan signal SCAN and the sensing gate signal SENSE can be the same gate signal, and the on-off timing of the scan transistor SCT in one subpixel SP and the on-off timing of the sensing transistor SENT can be the same.

The sensing transistor SENT can be turned on by the sensing gate signal SENSE having the turn-on level voltage, and can transmit the initialization voltage VINIT supplied from the initialization line INIT to the first node N1.

If the sensing transistor SENT is an N-type transistor, the sensing transistor SENT can be turned on by the sensing gate signal SENSE having a high level voltage, and can transmit the initialization voltage VINIT supplied from the initialization line INIT to the first node N1.

In addition, the sensing transistor SENT can be turned on by a sensing gate signal SENSE having a turn-on level voltage to transmit the voltage of the first node N1 to the initialization line INIT.

If the sensing transistor SENT is an N-type transistor, the sensing transistor SENT can be turned on by the sensing gate signal SENSE having a high level voltage to transmit the voltage of the first node N1 to the initialization line INIT.

The function of the sensing transistor SENT to transfer the voltage of the first node N1 to the initialization line INIT can be used when driving to sense the characteristic value of the subpixel SP. In this case, the voltage transferred to the initialization line INIT can be a voltage for calculating the characteristic value of the subpixel SP or a voltage reflecting the characteristic value of the subpixel SP.

The characteristic value of the subpixel SP can be a characteristic value of the driving transistor DT or the light emitting device ED. For example, the characteristic value of the driving transistor DT can include a threshold voltage and a mobility of the driving transistor DT. The characteristic value of the light emitting device ED can include the threshold voltage of the light emitting device ED.

The initialization line INIT can be connected to a power switch SPRE and a sampling switch SAM.

The power switch SPRE can control the connection between the initialization line INIT and an initialization voltage supply node. The initialization voltage VINIT output from the power supply can be supplied to the initialization voltage supply node, and the initialization voltage VINIT supplied to the initialization voltage supply node can be applied to the initialization line INIT through the power switch SPRE.

The sampling switch SAM can control the connection between the analog-to-digital converter ADC and the initialization line INIT. If the analog-to-digital converter ADC is connected to the initialization line INIT by the sampling switch SAM, the analog-to-digital converter ADC can convert the voltage (e.g., analog voltage) of the connected initialization line INIT into a sensing value corresponding to a digital value.

Depending on the driving of the subpixel SP, a line capacitor C_sen can be formed between the initialization line INIT and a ground GND, and the voltage of the initialization line INIT can correspond to the charge amount of the line capacitor C_sen.

Meanwhile, the analog-to-digital converter ADC can provide sensing data including sensing values to a compensator.

The compensator can detect the characteristic values of the circuit elements (e.g., light emitting device ED), driving transistor DT included in the corresponding subpixel SP based on the sensing data supplied from the analog-to-digital converter ADC, and can calculate a compensation value for reducing the characteristic value deviation between the circuit elements based on the characteristic value and store the calculated compensation value in the memory.

For example, the compensation value can be information calculated for reducing the characteristic value deviation between light emitting devices EDs or the characteristic value deviation between driving transistors DTs, and can include an offset and a gain for changing the data.

The display controller 140 can change the image data using the compensation value stored in the memory, and supply the changed image data to the data driving circuit 120.

The data driving circuit 120 can convert the changed image data DATA into a data voltage VDATA corresponding to an analog voltage using a digital-to-analog converter DAC and output, thereby realizing compensation.

In the example of FIG. 3, the driving transistor DT, the scan transistor SCT, and the sensing transistor SENT can be all N-type transistors, but the embodiments of the present disclosure are not limited thereto, and at least one of the driving transistor DT, the scan transistor SCT, and the sensing transistor SENT can be a P-type transistor.

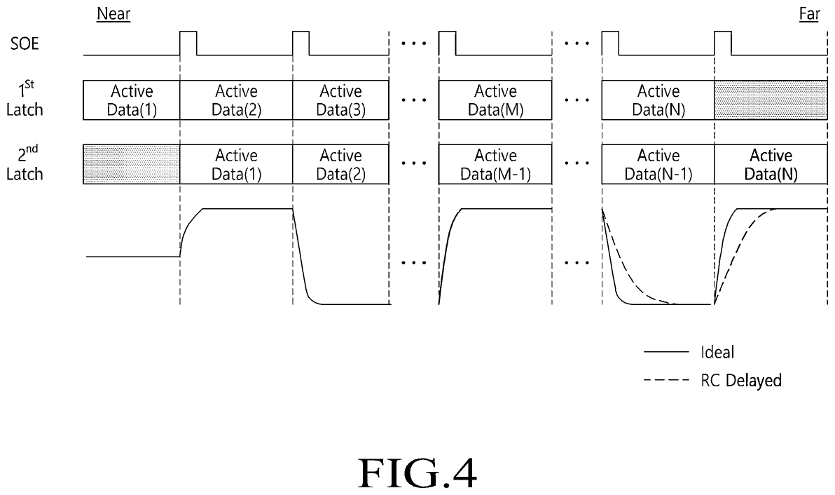

FIG. 4 illustrates change in the characteristics of a data voltage due to an RC delay in a display device according to example embodiments of the present disclosure.

Referring to FIG. 4, the data driving circuit 120 according to the embodiments of the present disclosure can include a first latch circuit 1^{st} Latch and a second latch circuit 2^{nd} Latch, without being limited thereto.

In addition, the data driving circuit 120 can further include a digital-to-analog converter DAC and an output buffer. The output buffer can include an output amplifier circuit.

The first latch circuit 1^{st} Latch can store image data Data provided from the display controller 140 as first digital data based on a sampling signal, and the second latch circuit 2^{nd} Latch can store first digital data output from the first latch circuit 1^{st} Latch as second digital data.

The digital-to-analog converter DAC can convert the second digital data into a data voltage, and an output buffer (i.e., an output amplifier circuit) can output the data voltage to the plurality of data lines DL.

In this case, the line resistance of the data line DL can increase as going from an area near the data driving circuit 120 to an area farther away. In addition, as the distance between the data line and the data driving circuit increases, the RC delay can increases, which can increase the data settling time. Therefore, the actual data voltage (i.e., RC delayed data voltage) can be not charged to the target data voltage (i.e., an ideal data voltage), so that the brightness fluctuations or the luminance variation can occur depending on the location within the display area DA.

The data driving circuit 120 can compensate for the RC delay according to the resistance (R) and capacitor (C) of the data line DL by adjusting a bias current of the output amplifier circuit.

However, in this case, since the settling due to an RC delay cannot be completely compensated for, there can occur a difference in data settling time between an area near the data driving circuit 120 and an area far from the data driving circuit 120. Accordingly, the data driving circuit 120 can compensate for the data settling time through the data overdriving compensation, thereby preventing or reducing luminance variations depending on the location.

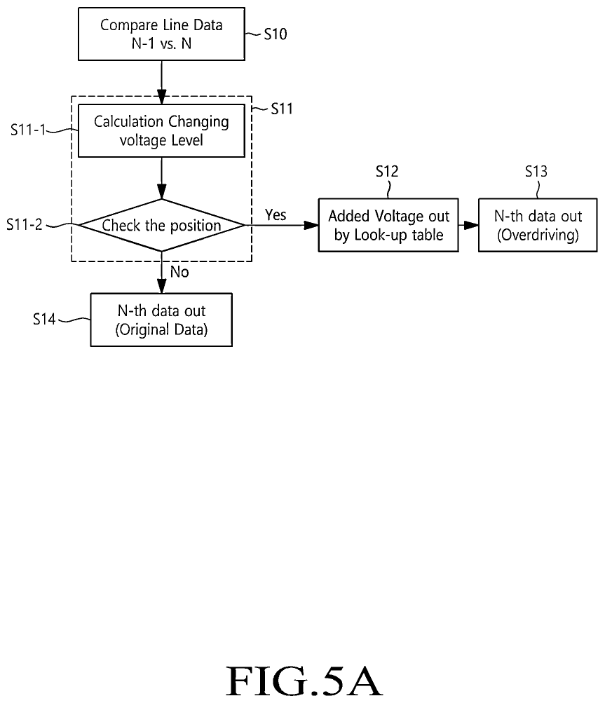

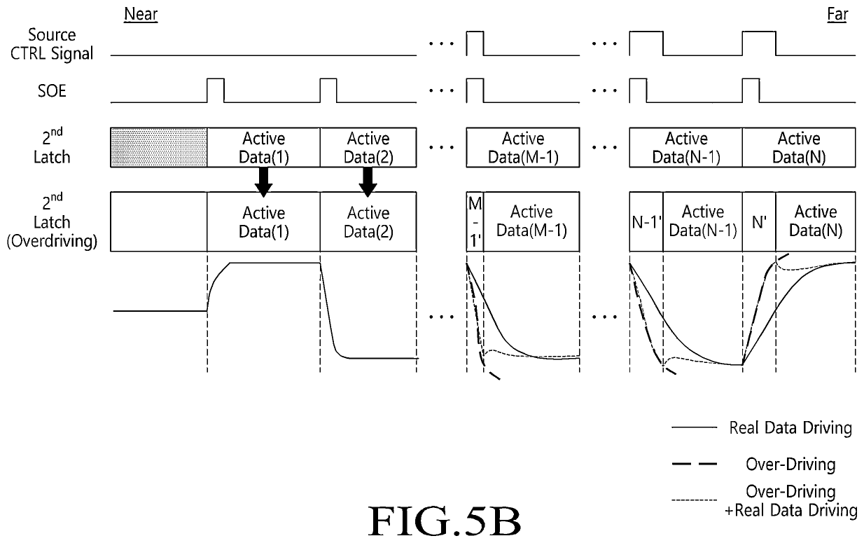

FIG. 5A and FIG. 5B illustrate a data overdriving compensation process of a display device 100 according to example embodiments of the present disclosure.

Referring to FIG. 5A, in the case that the (n−1)-th subpixel is an (N−1)-th subpixel connected to an (N−1)-th gate line and the n-th subpixel is an N-th subpixel connected to an N-th gate line, the data driving circuit 120 can compare the digital data of the (N−1)-th subpixel with the digital data of the N-th subpixel (S10 of FIG. 5A).

The data driving circuit 120 can determine whether to compensate for overdriving for the digital data of the N-th subpixel based on the comparison result of the digital data (S11).

For example, the data driving circuit 120 can calculate the amount of change in the data transition value of the digital data of the N-th subpixel compared to the digital data of the N-th subpixel (S11-1 of FIG. 5A), and, can estimate the position information of the N-th subpixel based on the change in the calculated data transition value. In addition, the data driving circuit 120 can determine whether to compensate for overdriving based on the estimated position information of the N-th subpixel (S11-2 of FIG. 5A).

Here, the position information of the N-th subpixel can include distance information between the data driving circuit 120 and the N-th subpixel.

In addition, the amount of change in the data transition value of the digital data of the th subpixel can mean the difference between the amount of transition of the digital data of the N-th subpixel and the amount of transition of the digital data of the (N−1)-th subpixel.

If the data transition value of the digital data of the N-th subpixel is greater than or equal to a preset threshold value, the data driving circuit 120 can determine a length of an overdriving period and a level of a overdriving voltage corresponding to the position information of the N-th subpixel based on a plurality of overdriving period information and a plurality of overdriving level information stored in a look-up table, and apply this to the digital data of the N-th subpixel to generate compensated digital data of the N-th subpixel (S12 of FIG. 5A).

For example, the look-up table can be provided in the data driving circuit 120, and the plurality of overdriving period information can include the length information of the plurality of overdriving periods according to the change in the length of the data line DL, and the plurality of overdriving level information can include the level information of the plurality of overdriving voltages according to the change in the length of the data line DL.

The data driving circuit 120 can generate an N-th data voltage corresponding to the compensated digital data of the N-th subpixel, and supply the N-th data voltage (i.e., the overdriven data voltage) to the data line DL (S13).

Meanwhile, the data driving circuit 120 can set a length value of the overdriving period corresponding to the position information of the N-th subpixel to ‘0’ if the data transition value of the digital data of the N-th subpixel is less than a preset threshold value (S14).

For example, if the data transition value is less than the threshold value, the data driving circuit 120 may not perform data overdriving compensation for the N-th subpixel, and generate an N-th data voltage corresponding to the uncompensated digital data, and supply the N-th data voltage (i.e., the original data voltage) to the data line DL (S14).

Referring to FIG. 5B, the data driving circuit 120 can perform the overdriving compensation for the data voltage (e.g., Active Data (M−1)) of an M-th subpixel to the data voltage (e.g., Active Data (N)) of the N-th subpixel based on the comparison result of the digital data, and the compensated digital data can be stored in the second latch 2^{nd} Latch.

In this case, the length of the overdriving period (M−1′, . . . , N−1′, N′) of the M-th subpixel to the N-th subpixel and the level of the overdriving voltage can be determined in response to the distance from the data driving circuit 120 to each subpixel.

For example, the length of the overdriving period (M−1′, . . . , N−1′, N′) and the level of the overdriving voltage can increase as the distance from the data driving circuit 120 increases.

The data driving circuit 120 can store the digital data (e.g., Active Data (1)) of a first subpixel in the second latch circuit 2^{nd} Latch without overdriving compensation.

In the case that the (n−1)-th subpixel is the first subpixel connected to the first gate line, the n-th subpixel is the second subpixel connected to the second gate line, and the data transition value of the digital data (e.g., Active Data (2)) of the second subpixel is less than a preset threshold value when compared with the digital data (e.g., Active Data (1)) of the first subpixel, the data driving circuit 120 can store the digital data (e.g., Active Data (2)) of a second subpixel in the second latch circuit 2^{nd} Latch without overdriving compensation.

According to FIG. 5B, the data driving circuit 120 can output digital data stored in the second latch circuit 2^{nd} Latch in response to the data timing control signal, and can generate a data voltage based on the digital data output from the second latch circuit 2^{nd} Latch.

For example, the data timing control signal can include at least one of a source output enable signal SOE and a source control signal (e.g., Source CTRL Signal).

The source output enable signal SOE can be a signal corresponding to the timing at which the digital data stored in the second latch circuit 2^{nd} Latch is output.

The data driving circuit 120 can receive a source output enable signal SOE from the display controller 140, or can receive a data control signal DCS including a timing control clock related to the source output enable signal SOE from the display controller 140 and directly generate the source output enable signal SOE.

For example, the source output enable signal SOE can include a first voltage section having a first voltage and a second voltage section having a second voltage at a higher level than the first voltage, and at least a part of the overdriving period (M−1′, . . . , N−1′, N′) can overlap with a period corresponding to the second voltage section.

The source control signal (e.g., Source CTRL Signal) can be a signal corresponding to the timing at which digital data stored in the second latch circuit 2^{nd} Latch is output. The length of the application period of the source control signal (e.g., Source CTRL Signal) can be set to be the same as the length of each overdriving period (M−1′, . . . , N−1′, N′).

Referring to FIG. 5B, the data applied during the remaining period excluding the overdriving period (M−1′, . . . , N−1′, N′) among the application periods of the overdriving compensated digital data (i.e., ‘2^{nd} Latch (Overdriving)’ of FIG. 5B) can be configured to be the same as the data applied during the remaining period excluding the period corresponding to the overdriving period (M−1′, . . . , N−1′, N′) among the application periods of the uncompensated digital data (i.e., ‘2^{nd} latch’ of FIG. 5B) (i.e., Active (M−1), . . . , Active (N−1), Active (N)).

For example, the overdriving period (M−1′, . . . , N−1′, N′) of the data voltage is not an additionally added period, but a period allocated within the application period of the existing data voltage, and after the overdriving voltage is applied during the overdriving period, there can be applied the same data voltage as the target data voltage.

In addition, the data driving circuit 120 can control a slope of the data voltage to be steeper by applying a voltage higher (or lower) than the target data voltage, for example, an overdriving voltage, depending on the polarity (′+′ or ‘−’) of the digital data voltage during the overdriving period (M−1′, . . . , N−1′, N′).

In addition, the data driving circuit 120 can control the data voltage to be the same or similar level as the target data voltage during the middle of the data voltage change due to the overdriving voltage, thereby enabling the target data voltage to be settled more quickly and preventing or reducing luminance variations depending on the location.

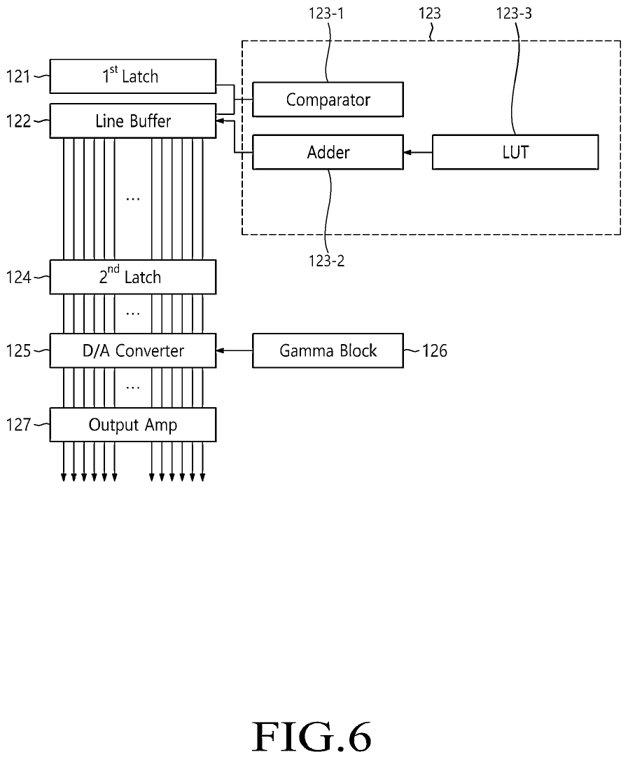

FIG. 6 illustrates a data driving circuit 120 according to example embodiments of the present disclosure.

Referring to FIG. 6, the data driving circuit 120 can include a first latch circuit 121, a line buffer 122, a data compensation circuit 123, a second latch circuit 124, and so on. Further, the data driving circuit 120 can further include a digital-to-analog conversion circuit 125, a gamma block (i.e., a gamma circuit) 126, and an output amplifier circuit 127, and so on. For example, the data compensation circuit 123 can comprise a comparator 123-1, an adder 123-2, and a look-up table 123-3, and so on.

In addition, the data driving circuit 120 can further include a shift register which receives image data and a data control signal DCS from the display controller 140 and generates a sampling signal based on the data control signal DCS.

For example, the shift register can generate a sampling signal by shifting the source start pulse according to the source sampling clock.

The first latch circuit 121 can store the first digital data of the n-th subpixel based on the sampling signal.

For example, the first latch circuit 121 can be configured to store the first digital data of the n-th subpixel based on a sampling signal corresponding to a data control signal applied from the display controller.

The line buffer 122 can store the second digital data of the (n−1)-th subpixel.

For example, the second digital data of the (n−1)-th subpixel can be digital data derived based on the comparison result between the first digital data of the (n−1)-th subpixel and the second digital data of an (n−2)-th subpixel.

The data compensation circuit 123 can update the second digital data of the n-th subpixel in the line buffer 122 based on the comparison result between the second digital data of the (n−1)-th subpixel stored in the line buffer 122 and the first digital data of the n-th subpixel stored in the first latch circuit 121, and for this purpose, can include a comparator 123-1, an adder 123-2, and a look-up table 123-3, and so on.

The comparator 123-1 can compare the second digital data of the (n−1)-th subpixel stored in the line buffer 122 with the first digital data of the n-th subpixel stored in the first latch circuit 121, and calculate the data transition value of the first digital data of the n-th subpixel as the comparison result.

The adder 123-2 can update the second digital data of the n-th subpixel in the line buffer 122 based on information corresponding to the data transition value among the plurality of overdriving period information and the plurality of overdriving level information stored in the look-up table 123-3.

The adder 123-2 can update the second digital data of the n-th subpixel in the line buffer 122 by applying an overdriving voltage of a level corresponding to the data transition value to the first digital data of the n-th subpixel during an overdriving period of a length corresponding to the data transition value.

For example, the data compensation circuit 123 can control the first digital data of the n-th subpixel stored in the first latch circuit 121 to be stored in the line buffer 122, and supply an overdriving voltage of a level corresponding to the data transition value to the first digital data of the n-th subpixel stored in the line buffer 122 through the adder 123-2 during an overdriving period of a length corresponding to the data transition value, thereby updating the first digital data of the n-th subpixel to the second digital data of the n-th subpixel.

If the data transition value is less than a preset threshold value, the data compensation circuit 123 can update the first digital data of the n-th subpixel to which the overdriving period is not applied to the second digital data of the n-th subpixel.

As one example, the data compensation circuit 123 of the data driving circuit 120 can update the line buffer with the first digital data of the n-th subpixel to which the overdriving period is not applied, as the second digital data of the n-th subpixel, if the data transition value is less than a preset threshold value.

For example, the data compensation circuit 123 can update the first digital data of the n-th subpixel stored in the first latch circuit 121 to the second digital data of the n-th subpixel in the line buffer 122 if the data transition value is less than a preset threshold value.

The second latch circuit 124 can receive the second digital data of the n-th subpixel from the line buffer 122, and output the second digital data of the n-th subpixel in response to a data timing control signal.

For example, the data timing control signal can include at least one of a source output enable signal SOE and a source control signal (i.e., Source CTRL Signal).

For example, a length of an application period of the source control signal (i.e., Source CTRL Signal) can be equal to a length of an overdriving period.

The digital-to-analog conversion circuit 125 can convert the second digital data of the n-th subpixel to a data voltage based on the gamma grayscale voltage received from the gamma block 126.

The output amplifier circuit 127 can amplify the data voltage received from the digital-to-analog conversion circuit 125 and output the amplified data voltage to the plurality of data lines DL.

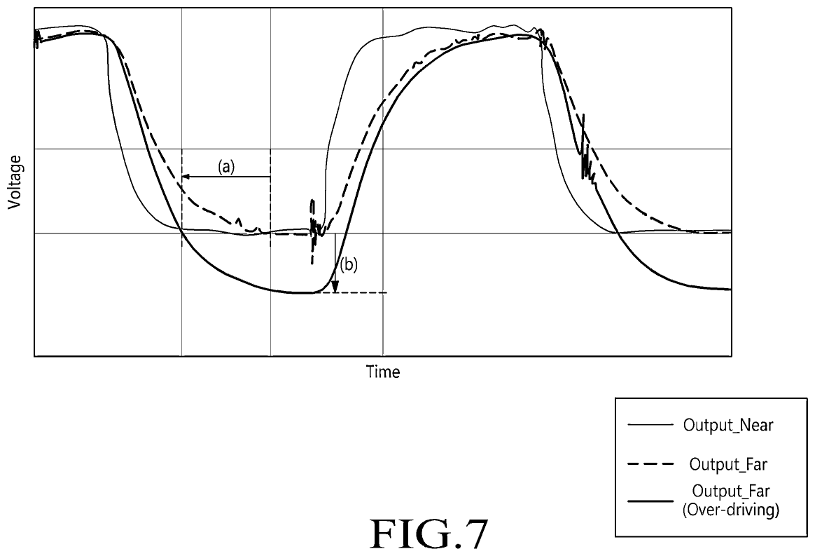

FIG. 7 illustrates a result of performing overdriving compensation in a display device 100 according to example embodiments of the present disclosure.

Particularly, FIG. 7 illustrates the results of measuring data voltage in the near area and the far area from the data driving circuit 120. ‘Output_Near’ can represent the data voltage measured in the near area, ‘Output_Far’ can represent the data voltage measured in the far area, and ‘Output_Far (over-driving)’ can represent the overdriving compensation result of the data voltage measured in the far area.

Referring to (a) of FIG. 7, the data settling time of the data voltage ‘Output_Far’ has increased by a specific amount compared to the data voltage ‘Output_Near’.

For example, in the far area, compared to the near area, a difference can occur in the data settling time due to an increase in RC delay by an increase in resistance value, and this RC delay can increase as the distance from the data driving circuit 120 supplied with the data voltage increases and as the resolution increases, which can have a disadvantageous effect on the data settling time.

In particular, as the display device 100 is driven at higher speed, the size of a single time (e.g., 1H Time) can decrease, and accordingly, the target data voltage is required to be normally settled within a single time (e.g., 1H Time) in order to drive normally. However, it is difficult to make the data settling time smaller due to the physical resistance value and capacitor value, and eventually, a difference in luminance can occur due to a difference in voltage settled at a set time for each location.

In order to solve this limitation, the display device 100 according to the embodiments of the present disclosure can reduce the data settling time due to the RC delay through overdriving compensation.

Referring to (b) of FIG. 7, the data voltage ‘Output_Far (over-driving)’ to which overdriving compensation is applied through the display device 100 can indicate the result of applying a voltage (i.e., an overdriving voltage) lower than the actual applied voltage during an overdriving period of a predetermined length. There is illustrated that the data settling time is reduced to almost the same or similar extent as the data settling time of the data voltage ‘Output_Near’ as the slope changes steeply by applying the overdriving voltage.

For example, the data voltage ‘Output_Far (over-driving)’ can converge to the target data voltage through overdriving compensation so as to settle the target data voltage within a single horizontal time (e.g., 1H) by, thereby preventing or reducing luminance fluctuations depending on the location due to voltage difference even when the resolution/panel size is large or when driving at high frequency.

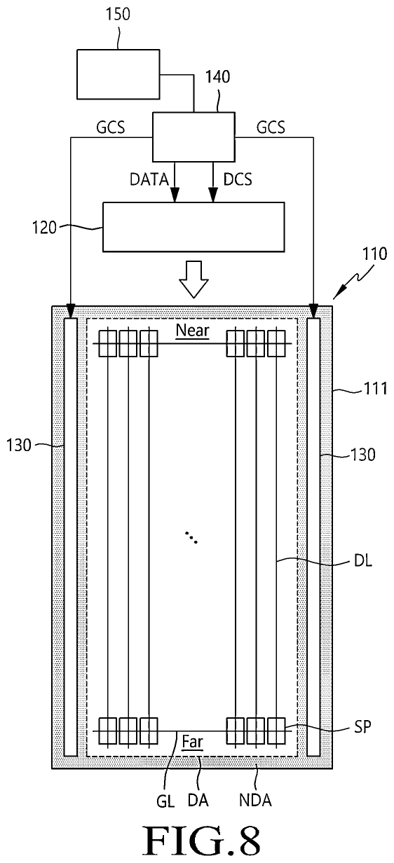

FIG. 8 illustrates an implementation example of a display device 100 according to example embodiments of the present disclosure.

Referring to FIG. 8, the display panel 110 can include a display area DA where an image is displayed and a non-display area NDA where an image is not displayed.

The display area DA can be an area where an image can be displayed, and can also be referred to as an active area. A plurality of subpixels SP for displaying an image can be disposed in the display area DA.

If the number of gate lines GL in the display panel 110 is N (where N is a positive integer), a first gate line, a second gate line, . . . , an (M−1)-th gate line, an M-th gate line, . . . , an (N−1)-th gate line and an N-th gate line (where M and N are positive integers satisfying the condition of N−1>M) can be disposed sequentially from an area near the data driving circuit 120 to an area far from the data driving circuit 120.

The non-display area NDA can be an area where an image is not displayed, and can be an outer area of the display area DA. The non-display area NDA can also be referred to as a bezel or a bezel area. The non-display area NDA can include a pad area.

All or a portion of the non-display area NDA can be an area visible from the front surface of the display device 100, or an area that is bent and invisible from the front surface of the display device 100 or an area that is covered by a case or housing of the display device 100.

For example, the non-display area NDA can include a plurality of non-display areas, such as a first non-display area, a second non-display area, a third non-display area, and a fourth non-display area, and so on. The first non-display area can be located outside the display area DA in a row direction. The second non-display area can be located outside the display area DA in the row direction, and can be located opposite the first non-display area. The third non-display area can be located outside the display area DA in a column direction. The fourth non-display area can be located outside the display area DA in the column direction, and can be located opposite the third non-display area.

Among the first to fourth non-display areas, the fourth non-display area can include a pad area to which a driving circuit is connected or bonded or joined, and the first to third non-display areas can have a very small size, but embodiments of the present disclosure are not limited thereto.

For another example, the boundary area between the display area DA and the non-display area NDA can be bent so that the non-display area NDA can be located below the display area DA.

If the user looks at the display device 100 from the front, the non-display area NDA shown to the user can be almost non-existent, but the embodiments of the present disclosure are not limited thereto.

According to the example of FIG. 8, the data driving circuit 120 can receive image data DATA in digital form from the display controller 140, convert the received image data DATA into an analog data signal (or also referred to as a data voltage) and output the data signal to a plurality of data lines DL.

The data driving circuit 120 can be connected to the display panel 110 by a tape automated bonding (TAB) method, can be connected to a conductive pad such as a bonding pad of the display panel 110 by a chip-on-glass (COG) or chip-on-panel (COP) method, or implemented by a chip-on-film (COF) method and connected to the display panel 110, but is not limited thereto. Alternatively, the data driving circuit 120 can be formed in a non-display area NDA of the display panel 110 as a gate-in-panel (GIP) type.

The data driving circuit 120 according to the embodiments of the present disclosure can reduce the data settling time through overdriving compensation for the data voltage provided to the display area DA, thereby minimizing or reducing the luminance variation depending on the location within the display area DA.

The gate driving circuit 130 can be implemented as a gate-in-panel (GIP) type, and can be formed in the non-display area NDA of the display panel 110. The gate driving circuit 130 can be disposed in both the non-display area NDA located at one outer side of the display area DA and the non-display area NDA located at the other outer side of the display area DA, but the embodiments of the present disclosure are not limited thereto. Alternatively, the gate driving circuit 130 can be disposed in only one of the non-display area NDA located at one outer side of the display area DA and the non-display area NDA located at the other outer side of the display area DA.

As another example, the gate driving circuit 130 can be disposed in the display area DA of the display panel 110. For example, the gate driving circuit 130 can be disposed over the partial area of the display area DA. As another example, the gate driving circuit 130 can be disposed over the entire area of the display area DA.

As an example, the gate driving circuit 130 can be disposed in one of a first partial area within the display area DA (for example, a left area or a right area within the display area DA) and a second partial area (e.g., a right area or a left area within the display area DA), without being limited thereto. As another example, the gate driving circuit 130 can be disposed in both of a first partial area (e.g., a left area or a right area within the display area DA) and a second partial area (e.g., a right area or a left area within the display area DA), without being limited thereto. As another example, the gate driving circuit 130 can be disposed over the entire area of the display area DA.

If the gate driving circuit 130 is disposed in the display area DA of the display panel 110, the gate driving circuit 130 can be vertically overlapped with the subpixels SP disposed in the display area DA, without being limited thereto.

For example, the gate driving circuit 130 can be vertically overlapped with the light emitting devices and transistors included in the subpixels SP arranged in the display area DA. The gate driving circuit 130 can be vertically overlapped with the plurality of light emitting devices and the plurality of transistors included in the plurality of subpixels SP arranged in the display area DA. The gate driving circuit 130 can include a plurality of transistors. The plurality of transistors included in the gate driving circuit 130 can be vertically overlapped with the plurality of light emitting devices and the plurality of transistors included in the plurality of subpixels SP arranged in the display area DA. Each of the plurality of transistors included in the gate driving circuit 130 can include an active layer including a first semiconductor material, and each of the plurality of transistors included in the subpixels SP can include an active layer including a second semiconductor material. For example, the first semiconductor material and the second semiconductor material can be substantially the same. For another example, the first semiconductor material and the second semiconductor material can be different from each other. For example, the first semiconductor material can be a silicon-based semiconductor material (e.g., Low Temperature Poly Silicone; LTPS), and the second semiconductor material can be an oxide semiconductor material. For example, the active layer can be a semiconductor layer, but is not limited thereto.

The oxide semiconductor material can include a metal oxide such as zinc (Zn), indium (In), gallium (Ga), tin (Sn), and titanium (Ti) or a combination of a metal such as zinc (Zn), indium (In), gallium (Ga), tin (Sn), or titanium (Ti) and its oxide. Specifically, the oxide semiconductor material can include zinc oxide (ZnO), zinc-tin oxide (ZTO), zinc-indium oxide (ZIO), indium oxide (InO), titanium oxide (TiO), indium-gallium-zinc oxide (IGZO), indium-zinc-tin oxide (IZTO), indium zinc oxide (IZO), indium gallium tin oxide (IGTO), and indium gallium oxide (IGO), but is not limited thereto.

The display controller 140 can be connected to a host system 150 to perform an overall control function related to driving the display panel 110, and can control the operation of the data driving circuit 120 and the gate driving circuit 130.

The display controller 140 can receive input image data from a host system 150 and supply image data Data based on the input image data to the data driving circuit 120.

The display device 100 can further include a power management integrated circuit, and the power management integrated circuit can supply various voltages or currents to the data driving circuit 120 and the gate driving circuit 130, or control various voltages or currents to be supplied.

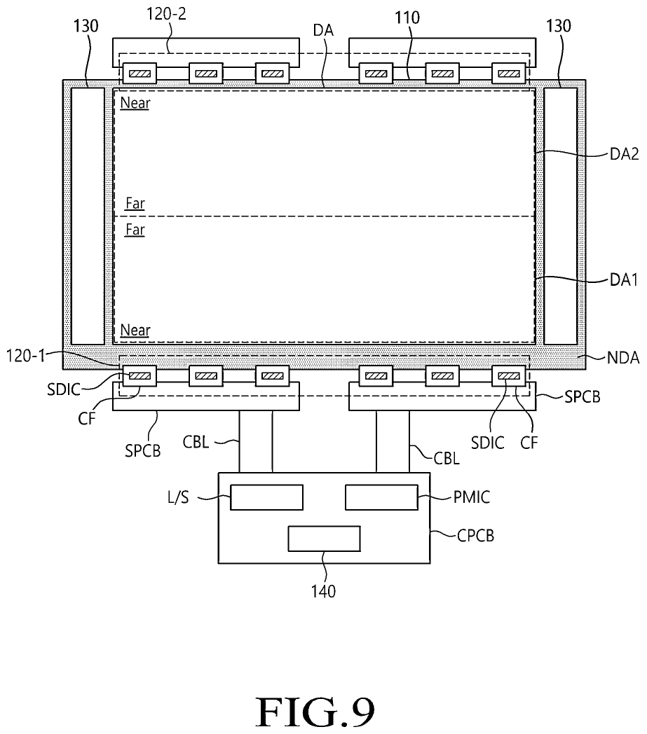

FIG. 9 illustrates another implementation example of a display device 100 according to example embodiments of the present disclosure.

Referring to FIG. 9, the display panel 110 can include a display area DA) where an image is displayed and a non-display area NDA where an image is not displayed.

The data driving circuit 120 can include a plurality of source driver integrated circuits SDICs, and can be implemented in a chip-on-film (COF) manner. Each of the plurality of source driver integrated circuits SDICs can be mounted on a circuit film CF connected to the non-display area NDA of the display panel 110. Here, the circuit film CF is also referred to as a flexible printed circuit.

According to the implementation example of FIG. 9, the gate driving circuit 130 can be implemented in a gate-in-panel (GIP) type and can be directly disposed on the substrate of the display panel 110. Alternatively, the gate driving circuit 130 can be integrated and arranged on the display panel 110, or each gate driving circuit 130 can be implemented by a chip-on-film COF method in which an element is mounted on a film connected to the display panel 110.

The gate driving circuit 130 can be formed in the non-display area NDA of the display panel 110, without being limited thereto. Alternatively, the gate driving circuit 130 can be disposed in the display area DA of the display panel 110. According to the implementation example of FIG. 9, the gate driving panel circuit GPC can be disposed in both the non-display area NDA located at one outer side of the display area DA and the non-display area NDA located at the other outer side of the display area DA.

The display device 100 can include at least one source printed circuit board SPCB for circuit connection between a plurality of source driver integrated circuits SDIC and other devices 140 (e.g., L/S, PMIC, etc.), and a control printed circuit board CPCB for mounting control components and various electrical devices.

A circuit film CF on which a source driver integrated circuit SDIC is mounted can be connected to at least one source printed circuit board SPCB. For example, a circuit film CF on which a source driver integrated circuit SDIC is mounted can have one side electrically connected to a display panel 110 and the other side electrically connected to a source printed circuit board SPCB.

The display controller 140 and a power management integrated circuit PMIC can be mounted on the control printed circuit board CPCB, without being limited thereto. Further, a level shifter L/S can be mounted on the control printed circuit board CPCB.

The display controller 140 can perform an overall control function related to driving the display panel 110, and can control the operation of a plurality of source driver integrated circuits SDIC and gate driving panel circuits GPC.

The power management integrated circuit PMIC can supply various voltages or currents to the plurality of source driver integrated circuits SDICs and gate driving circuits 130, or control the various voltages or currents to be supplied.

At least one source printed circuit board SPCB and a control printed circuit board CPCB can be connected to each other. For example, at least one source printed circuit board SPCB and a control printed circuit board CPCB can be connected to each other in a circuit manner through at least one connection cable CBL. Here, for example, the connection cable CBL can be one of a flexible printed circuit FPC and a flexible flat cable FFC, without being limited thereto.

At least one source printed circuit board SPCB and a control printed circuit board CPCB can be implemented by being integrated into one printed circuit board.

A display device 100 according to example embodiments of the present disclosure can further include a level shifter L/S for adjusting a voltage level of a signal. For example, the level shifter L/S can be disposed on a control printed circuit board CPCB or a source printed circuit board SPCB.

The level shifter L/S can output signals required for gate driving to the gate driving circuit 130 of a GIP type.

For example, a power management integrated circuit PMIC can output a signal to the level shifter L/S. The level shifter L/S can adjust the voltage level of a signal input from the power management integrated circuit PMIC. The signal whose voltage level is adjusted in the level shifter L/S can be input to a gate driving panel circuit GPC.

For example, the level shifter L/S can output a plurality of clock signals with different phases to the gate driving panel circuit GPC. The gate driving panel circuit GPC can generate a plurality of gate signals (e.g., scan signals SCAN1, SCAN2, SCAN3; SC), emission control signals (e.g., EM1, EM2; EM) based on the plurality of clock signals input from a level shifter L/S, and output the plurality of gate signals to a plurality of gate lines (e.g., scan lines, emission control lines, etc.).

The non-display area NDA of the display panel 110 can include a gate bezel area corresponding to the area where the gate driving circuit 130 is disposed. The gate bezel area can mean an area where the gate driving circuit 130 of the GIP type and various lines connected to the gate driving circuit 130 are disposed.

The various lines connected to the gate driving circuit 130 can include a plurality of clock lines, at least one high-potential voltage line to which a high-level gate voltage is applied, and at least one low-potential voltage line to which a low-level gate voltage is applied, and so on.

In the gate bezel area, a low-potential voltage line can be disposed in an area corresponding to a first side of the gate driving circuit 130 (e.g., an area between the first side of the gate driving circuit 130 and the display area DA), and a high-potential voltage line can be disposed in an area corresponding to a second side of the gate driving circuit 130 opposite the first side. For example, the high-potential voltage line and the low-potential voltage line can be arranged separately on two sides of the gate driving circuit 130.

According to the arrangement of the power lines described above, the high-potential voltage line and the low-potential voltage line can be arranged separately on the left and right sides of the gate driving circuit 130, thereby preventing or reducing overlap between the high-potential voltage line and the low-potential voltage line so as to stabilize the high-level gate voltage and the low-level gate voltage.

The display panel 110 can include a first panel area DA1 and a second panel area DA2. In addition, the data driving circuit 120 can include a first data driving circuit 120-1 for supplying data voltages to a plurality of data lines DL provided in the first panel area DA1, and a second data driving circuit 120-2 for supplying data voltages to a plurality of data lines DL provided in the second panel area DA2.

For example, the first data driving circuit 120-1 and the second data driving circuit 120-2 can be disposed on two sides of the display panel 110. As one example, the first data driving circuit 120-1 and the second data driving circuit 120-2 can be arranged separately on the upper and lower sides of the gate driving circuit 130.

In the first panel area DA1, if the number of gate lines GL disposed on the display panel 110 is N, a first gate line, a second gate line, . . . , and a N/2-th gate line can be sequentially disposed from an area near the first data driving circuit 120-1 to an area far from the first data driving circuit 120-1. In the second panel area DA2, if the number of gate lines GL disposed on the display panel 110 is N, a first gate line, a second gate line, . . . , and a N/2-th gate line can be sequentially arranged from an area near the second data driving circuit 120-2 to an area far from the second data driving circuit 120-2.

As one example, the first data driving circuit 120-1 and the second data driving circuit 120-2 can be connected to the control printed circuit board CPCB.

The first data driving circuit 120-1 can be connected to a control printed circuit board CPCB through at least one connection cable CBL.

The second data driving circuit 120-2 can be connected to the control printed circuit board CPCB through lines arranged in the non-display area NDA of the display panel 110.

In addition, the second data driving circuit 120-2 can be connected to the control printed circuit board CPCB through at least one connection cable CBL outside the display panel 110.

Each of the first data driving circuit 120-1 and the second data driving circuit 120-2 according to the embodiments of the present disclosure can reduce the data settling time through overdriving compensation for the data voltage provided to each of the first panel area DA1 and the second panel area DA2, thereby minimizing or reducing the luminance variation according to the position within the first panel area DA1 and the second panel area DA2.

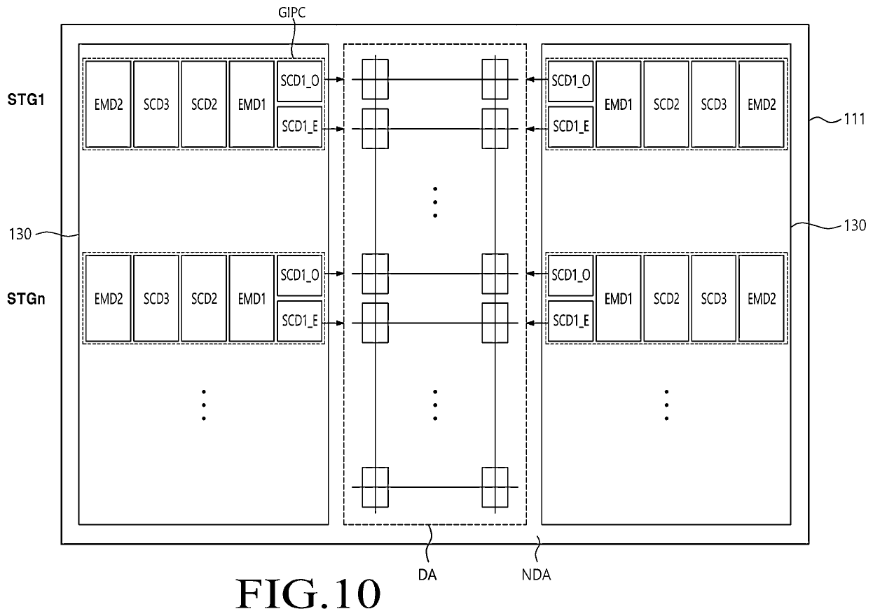

FIG. 10 illustrates a gate driving circuit 130 according to example embodiments of the present disclosure.

Referring to FIG. 10, the gate driving circuit 130 can include a plurality of GIP circuits GIPC. In this case, the plurality of GIP circuits GIPC can be disposed in a non-display area NDA corresponding to each of a plurality of stages STG.

For example, the plurality of GIP circuits GIPC can include a GIP circuit GIPC disposed in a left non-display area NDA and a GIP circuit GIPC disposed in a right non-display area NDA based on the display area DA corresponding to each of the plurality of stages STG, but is not limited thereto, and the GIP circuit GIPC can be disposed only in a non-display area NDA corresponding to either the left or right of the display area DA.

Further, two GIP circuits GIPC respectively disposed in the left non-display area NDA and the right non-display area NDA corresponding to each stage STG can be connected to two gate lines GL to apply gate signals, but the embodiments of the present disclosure are not limited thereto, and the two GIP circuits GIPC respectively disposed in the left non-display area NDA and the right non-display area NDA can be connected to one gate line each.

According to one embodiment, if the GIP circuit GIPC is connected to two gate lines GL to apply gate signals, the GIP circuit GIPC can include a plurality of first scan drivers SCD1_O and SCD1_E, a second scan driver SCD2, a third scan driver SCD3, a first emission control driver EMD1, and a second emission control driver EMD2, without being limited thereto.

According to another embodiment, if the GIP circuit GIPC is connected to two gate lines GL and applies a gate signal, the GIP circuit GIPC can include not only a plurality of the first scan drivers SCD1_O and SCD1_E, but also a plurality of the second scan driver SCD2, a plurality of the third scan driver SCD3, a plurality of the first emission control driver EMD1 and a plurality of the second emission control driver EMD2 which correspond to the two gate lines GL.

According to another embodiment, if the GIP circuit GIPC is connected to one gate line GL and applies a gate signal, the GIP circuit GIPC can include one first scan driver, one second scan driver SCD2, one third scan driver SCD3, one first emission control driver EMD1 and one second emission control driver EMD2. Referring to FIG. 2 and FIG. 10, each of the plurality of first scan drivers SCD1_O and SCD1_E disposed in the n-th stage STGn can output a first scan signal SCAN1 to a plurality of first scan lines SCL1 corresponding to each of the (n−1)-th gate line and the n-th gate line.

The (n−1)-th gate line and the n-th gate line can share at least one gate control signal line among the second scan line SCL2, the third scan line SCL3, the first emission control line EML1, and the second emission control line EML2, but the embodiments of the present disclosure are not limited thereto.

As one example, a second scan driver SCD2, a third scan driver SCD3, a first emission control driver EMD1 and a second emission control driver EMD2 disposed in the n-th stage STGn can be connected to respective one second scan line, one third scan line SCL3, one first emission control line EML1 and one second emission control line EML2 corresponding to the (n−1)-th gate line and the n-th gate line.

For example, a second scan driver SCD2 disposed in the n-th stage STGn can output a second scan signal SCAN2 to one second scan line SCL2 corresponding to the (n−1)-th gate line and the n-th gate line.

In addition, a third scan driver SCD3 disposed in the n-th stage STGn can output a third scan signal SCAN3 to one third scan line SCL3 corresponding to the (n−1)-th gate line and the n-th gate line.

In addition, a first emission control driver EMD1 arranged in the n-th stage STGn can output a first emission control signal EM1 to one first emission control line EML1 corresponding to the (n−1)-th gate line and the n-th gate line.

In addition, a second emission control driver EMD2 arranged in the n-th stage STGn can output the second emission control signal EM2 to one second emission control line EML2 corresponding to the (n−1)-th gate line and the n-th gate line.

Each of the plurality of drivers provided in the GIP circuit GIPC can receive at least one clock signal CLK from the display controller 140, receive a gate high voltage VGH and a gate low voltage VGL from the power management integrated circuit, and output a corresponding gate signal.

For example, each of the plurality of drivers provided in the GIP circuit GIPC can include an output buffer configured with a pull-up transistor and a pull-down transistor to output a gate signal based on a gate high voltage VGH and a gate low voltage VGL, and a control circuit for controlling an Q node and an QB node corresponding to the gate nodes of each of the pull-up transistor and the pull-down transistor based on a clock signal CLK.

As an example, at least one GIP circuit GIPC among the plurality of GIP circuits GIPC can receive a start signal VST applied to a control circuit provided in each of the plurality of drivers from the display controller 140, and the control circuit can control the Q node and the QB node based on the start signal VST and the clock signal CLK).

For example, each of the second scan driver SCD2, the third scan driver SCD3, the first emission control driver EMD1, and the second emission control driver EMD2 arranged in the first stage STG1 can output the second scan signal SCAN2, the third scan signal SCAN3, the first emission control signal EM1, and the second emission control signal EM2 based on a first clock signal CLK1, the gate high voltage VGH, and the gate low voltage VGL.

In addition, among the plurality of first scan drivers SCD1_O and SCD1_E arranged in the first stage STG1, a first scan driver SCD1_O corresponding to the first gate line can generate the first scan signal SCAN1 based on the first clock signal CLK1, the gate high voltage VGH, and the gate low voltage VGL, and a first scan driver SCD1_E corresponding to the second gate line can generate the first scan signal SCAN1 based on the second clock signal CLK2, the gate high voltage VGH, and the gate low voltage VGL.

For example, each of the second scan driver SCD2, the third scan driver SCD3, the first emission control driver EMD1, and the second emission control driver EMD2 arranged in a second stage STG2 can output the second scan signal SCAN2, the third scan signal SCAN3, the first emission control signal EM1, and the second emission control signal EM2 based on the second clock signal CLK2, the gate high voltage VGH, and the gate low voltage VGL.

In addition, among the plurality of first scan drivers SCD1_O and SCD1_E arranged in the second stage STG2, the first scan driver SCD1_O corresponding to the third gate line can generate the first scan signal SCAN1 based on the third clock signal CLK3, the gate high voltage VGH, and the gate low voltage VGL, and the first scan driver SCD1_E corresponding to the fourth gate line can generate the first scan signal SCAN1 based on the fourth clock signal CLK4, the gate high voltage VGH, and the gate low voltage VGL.

As one example, each of the second scan driver SCD2, the third scan driver SCD3, the first emission control driver EMD1, and the second emission control driver EMD2 arranged in odd stages (e.g., STG1, STG3, etc.) among the plurality of stages STG and each of the second scan driver SCD2, the third scan driver SCD3, the first emission control driver EMD1, and the second emission control driver EMD2 arranged in even stages (e.g., STG2, STG4, etc.) can output a gate signal based on different clock signals.

For example, each of the second scan driver SCD2, the third scan driver SCD3, the first emission control driver EMD1, and the second emission control driver EMD2 arranged in odd stages (e.g., STG1, STG3, etc.) among the plurality of stages STG can output a gate signal based on the first clock signal CLK1, and each of the second scan driver SCD2, the third scan driver SCD3, the first emission control driver EMD1, and the second emission control driver EMD2 arranged in even stages (e.g., STG2, STG4, etc.) can output a gate signal based on the second clock signal CLK2, but the embodiments of the present disclosure are not limited thereto.

The GIP circuit GIPC can include a plurality of first scan drivers SCD1_O and SCD1_E arranged in an area closest to the display area DA, and can include a first emission control driver EMD1, a second scan driver SCD2, a third scan driver SCD3, and a second emission control driver EMD2 which are disposed sequentially in a direction away from the display area DA, but the embodiments of the present disclosure are not limited thereto.

In addition, the area sizes of each of the plurality of first scan drivers SCD1_O and SCD1_E, the first emission control driver EMD1, the second scan driver SCD2, the third scan driver SCD3, and the second emission control driver EMD2 can be the same as each other, or can be configured differently.

For example, each of the area size of the first scan driver SCD1_O and the area size of the first scan driver SCD1_E can be smaller than that of the first emission control driver EMD1, the second scan driver SCD2, the third scan driver SCD3, and the second emission control driver EMD2 which can be the same as each other in the area size, without being limited thereto.

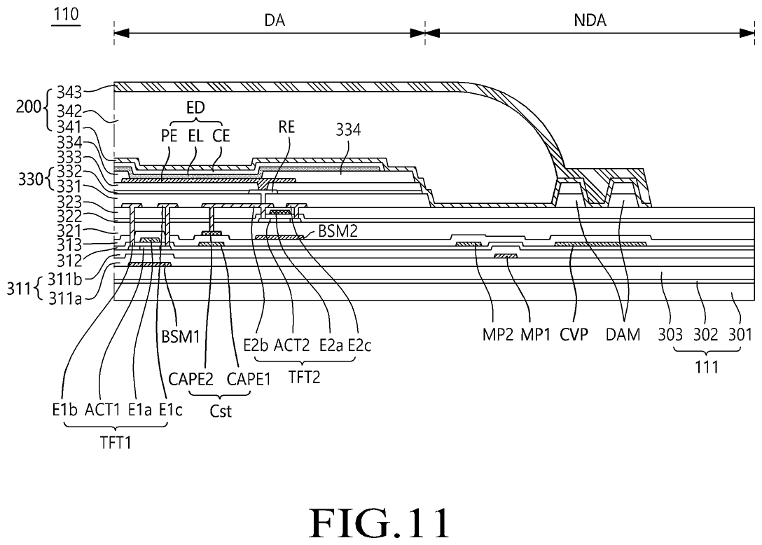

FIG. 11 illustrates an implementation example of a display panel 110 according to example embodiments of the present disclosure. Specifically, FIG. 11 illustrates a cross-sectional view of a display panel 110 according to the sub-pixel circuit of FIG. 2.

Referring to FIG. 11, the display panel 110 according to example embodiments of the present disclosure can include a transistor portion, a light emitting device portion, and an encapsulation portion, but the embodiments of the present disclosure are not limited thereto.

A substrate 111 can be a single layer or a multilayer. If the substrate 111 is a multilayer, the substrate 111 can include a first substrate 301, an intermediate substrate layer (or intermediate layer) 302, and a second substrate 303. The intermediate substrate layer 302 can be located between the first substrate 301 and the second substrate 303. For example, each of the first substrate 301 and the second substrate 303 can be a polyimide (PI) layer, but embodiments of the present disclosure are not limited thereto. The intermediate substrate layer 302 can be an inorganic insulating layer, but embodiments of the present disclosure are not limited thereto. The intermediate substrate layer 302 can block the charge from affecting the transistors placed on the second substrate 303 through the second substrate 303, which is a polyimide layer, when the charge is charged to the first substrate 301 as a polyimide layer.

In addition, the intermediate substrate layer 302 can block the moisture components from penetrating upward through the second substrate 303 and can block the moisture components from affecting the transistors placed on the second substrate 303. For example, the intermediate substrate layer 302 can be formed of a single layer of silicon nitride (SiNx) or silicon oxide (SiOx), or a multilayer thereof, and can also be formed of a double layer of silicon dioxide (SiO₂) and silicon nitride (SiNx), but is not limited thereto.

The transistor portion can include a substrate 111, insulating layers 311, 312, 313, 321, 322 and 323 on the substrate 111, thin film transistors TFT1 and TFT2, a storage capacitor Cst, and various electrodes or signal lines, and so on.

The thin film transistors TFT1 and TFT2 included in the transistor portion can include a first thin film transistor TFT1 and a second thin film transistor TFT2.

The first thin film transistor TFT1 can include a first active layer ACT1, a first electrode E1a, a second electrode E1b, and a third electrode E1c.

The first electrode E1a can be a gate electrode, the second electrode E1b can be a source electrode or a drain electrode, and the third electrode E1c can be a drain electrode or a source electrode. Hereinafter, for convenience of explanation, the first electrode E1a is referred to as a first gate electrode E1a, the second electrode E1b is referred to as a first source electrode E1b, and the third electrode E1c is referred to as a first drain electrode E1c. However, the embodiments of the present disclosure are not limited thereto.

The first electrode E1a can have a multilayer structure including a transparent conductive film and an opaque conductive film having high reflective efficiency. The transparent conductive film can be made of a material having a relatively high work function value such as indium-tin-oxide (ITO) or indium-zinc-oxide (IZO), and the opaque conductive film can have a single-layer or multi-layer structure including Al, Ag, Cu, Pb, Mo, Ti or an alloy thereof.

The first active layer ACT1 can include a first semiconductor material, but the embodiments of the present disclosure are not limited thereto. For example, the first semiconductor material can include an oxide semiconductor, amorphous silicon, polysilicon, or low-temperature polysilicon (LTPS), but the embodiments of the present disclosure are not limited thereto. The first thin film transistor TFT1 can be implemented as a p-channel transistor or an n-channel transistor, but the embodiments of the present disclosure are not limited thereto.

The second thin film transistor TFT2 can include a second active layer ACT2, a fourth electrode E2a, a fifth electrode E2b, and a sixth electrode E2c.

The fourth electrode E2a can be a gate electrode, the fifth electrode E2b can be a source electrode or a drain electrode, and the sixth electrode E2c can be a drain electrode or a source electrode. Hereinafter, for convenience of explanation, the fourth electrode E2a is referred to as a second gate electrode E2a, the fifth electrode E2b is referred to as a second source electrode E2b, and the sixth electrode E2c is referred to as a second drain electrode E2c. However, the embodiments of the present disclosure are not limited thereto.

The second active layer ACT2 can include a second semiconductor material, and the embodiments of the present disclosure are not limited thereto. For example, the second semiconductor material can include an oxide semiconductor, amorphous silicon, polysilicon, or low-temperature polysilicon (LTPS), but embodiments of the present disclosure are not limited thereto. The second thin film transistor TFT2 can be implemented as a p-channel transistor or an n-channel transistor, but embodiments of the present disclosure are not limited thereto.

For example, one of the first active layer ACT1 of the first thin film transistor TFT1 and the second active layer ACT2 of the second thin film transistor TFT2 can include an oxide semiconductor material. For another example, one of the first active layer ACT1 of the first thin film transistor TFT1 and the second active layer ACT2 of the second thin film transistor TFT2 can include a low-temperature polysilicon semiconductor material. For another example, the first active layer ACT1 of the first thin film transistor TFT1 and the second active layer ACT2 of the second thin film transistor TFT2 can include an oxide semiconductor material. For another example, the first active layer ACT1 of the first thin film transistor TFT1 and the second active layer ACT2 of the second thin film transistor TFT2 can include a low-temperature polysilicon semiconductor material. For another example, among the first thin film transistor TFT1 and the second thin film transistor TFT2, a driving transistor DT can be configured with an oxide semiconductor as an active layer, and a scanning transistor ST can be configured with a low-temperature polysilicon as an active layer. For another example, among the first thin film transistor TFT1 and the second thin film transistor TFT2, the driving transistor DT can be configured with a low-temperature polysilicon as an active layer, and the scanning transistor ST can be configured with an oxide semiconductor as an active layer. For another example, the transistor included in the gate driving circuit 130 of the gate-in-panel (GIP) type can be configured with an oxide semiconductor or a low-temperature polysilicon as an active layer. For another example, all the transistors configured on the substrate 111 and the transistor included in the gate driving circuit 130 of the gate-in-panel (GIP) type can be configured with an oxide semiconductor as an active layer.

The second thin film transistor TFT2 can be positioned higher from the substrate 111 than the first thin film transistor TFT1.

For example, the second active layer ACT2 of the second thin film transistor TFT2 can be positioned higher from the substrate 111 than the first active layer ACT1 of the first thin film transistor TFT1.

For example, the fourth electrode E2a of the second thin film transistor TFT2 can be positioned higher from the substrate 111 than the first electrode E1a of the first thin film transistor TFT1.

A first buffer layer 311 can be located under the first active layer ACT1 of the first thin film transistor TFT1, and a second buffer layer 321 can be located under the second active layer ACT2 of the second thin film transistor TFT2. For example, the first active layer ACT1 of the first thin film transistor TFT1 can be positioned on the first buffer layer 311, and the second active layer ACT2 of the second thin film transistor TFT2 can be positioned on the second buffer layer 321. The second buffer layer 321 can be positioned higher than the first buffer layer 311.

The storage capacitor Cst can be disposed within various metal layers within the display panel 110. For example, the storage capacitor Cst can include a first capacitor electrode CAPE1 and a second capacitor electrode CAPE2.

The light emitting device portion can include a plurality of light emitting device ED disposed on a planarization layer 330. Each of the plurality of light emitting device ED can include a pixel electrode PE, an emission layer EL, and a common electrode CE. The emission layer EL can be disposed between the pixel electrode PE and the common electrode CE.

For example, the pixel electrode PE can be an anode electrode AND, and the common electrode CE can be a cathode electrode CAT.

The encapsulation portion can include an encapsulation layer 200 on a plurality of light emitting device ED. The encapsulation layer 200 can be a single layer or a multilayer, but the embodiments of the present disclosure are not limited thereto. In addition to the encapsulation layer 200, the encapsulation portion can further include a dam DAM.

The encapsulation portion (e.g., an encapsulation layer) can include a plurality of encapsulating layers including at least one inorganic encapsulating layer, and at least one organic encapsulating layer. For example, the encapsulation portion can have a structure in which at least one organic encapsulating layer is disposed between inorganic encapsulating layers. The uppermost layer of the encapsulating unit can be the inorganic encapsulating layer, without being limited thereto.

A first buffer layer 311 can be disposed on a substrate 111. The first buffer layer 311 can be a single layer or a multilayer, but the embodiments of the present disclosure are not limited thereto. If the first buffer layer 311 is a multilayer, the first buffer layer 311 can include a lower buffer layer 311a and an upper buffer layer 311b disposed on the lower buffer layer 311a.

The first active layer ACT1 of the first thin film transistor TFT1 can be disposed on the first buffer layer 311. The first active layer ACT1 can include a channel region in which a channel is formed, a source connection region on one side of the channel region, and a drain connection region on the other side of the channel region.

A first insulating layer 312 can be disposed on the first active layer ACT1 of the first thin film transistor TFT1. The first gate electrode E1a of the first thin film transistor TFT1 can be disposed on the first insulating layer 312. A second insulating layer 313 can be disposed on the first gate electrode E1a of the first thin film transistor TFT1. The first insulating layer 312 can be a gate insulating layer, but the embodiments of the present disclosure are not limited thereto. The second insulating layer 313 can be an interlayer insulating layer, but the embodiments of the present disclosure are not limited thereto.

The second buffer layer 321 can be disposed on the second insulating layer 313.

The second active layer ACT2 of the second thin film transistor TFT2 can be disposed on the second buffer layer 321. The second active layer ACT2 can include a channel region in which a channel is formed, a source connection region on one side of the channel region, and a drain connection region on the other side of the channel region.

A third insulating layer 322 can be disposed on the second active layer ACT2 of the second thin film transistor TFT2. The second gate electrode E2a of the second thin film transistor TFT2 can be disposed. The fourth insulating layer 323 can be disposed on the second gate electrode E2a of the second thin film transistor TFT2. The third insulating layer 322 can be a gate insulating layer, but the embodiments of the present disclosure are not limited thereto. A fourth insulating layer 323 can be an interlayer insulating layer, but the embodiments of the present disclosure are not limited thereto.

The first source electrode E1b and the first drain electrode E1c of the first thin film transistor TFT1 and the second source electrode E2b and the second drain electrode E2c of the second thin film transistor TFT2 can be disposed on the fourth insulating layer 323.

The first source electrode E1b and the first drain electrode E1c of the first thin film transistor TFT1 can be connected to the source connection region and the drain connection region of the first active layer ACT1 through the holes passing through the fourth insulating layer 323, the third insulating layer 322, the second buffer layer 321, the second insulating layer 313, and the first insulating layer 312, respectively.

The second source electrode E2b and the second drain electrode E2c of the second thin film transistor TFT2 can be connected to the source connection region and the drain connection region of the second active layer ACT2 through the holes passing through the fourth insulating layer 323 and the third insulating layer 322, respectively.

The first source electrode E1b and the first drain electrode E1c of the first thin film transistor TFT1, and the second source electrode E2b and the second drain electrode E2c of the second thin film transistor TFT2 can include a first metal, and can be disposed within a first metal layer. Here, the first metal and the first metal layer can be referred to as a first source-drain metal and a first source-drain metal layer.

As an example, the storage capacitor Cst can be formed by a first capacitor electrode CAPE1 and a second capacitor electrode CAPE2. In some cases, the storage capacitor Cst can be formed by three or more capacitor electrodes, and can be in the form of two or more capacitors connected in parallel.

Each of the first capacitor electrode CAPE1 and the second capacitor electrode CAPE2 can be disposed on various metal layers disposed within the display panel 110.

For example, the first capacitor electrode CAPE1 can include the same first gate metal as the first gate electrode E1a of the first thin film transistor TFT1 on the first insulating layer 312, and can be disposed within the first gate metal layer, but the embodiments of the present disclosure are not limited thereto. For example, the second capacitor electrode CAPE2 can be disposed on the second insulating layer 313.

The second source electrode E2b of the second thin film transistor TFT2 can be electrically connected to the second capacitor electrode CAPE2. For example, the second source electrode E2b of the second thin film transistor TFT2 can be electrically connected to the second capacitor electrode CAPE2 through a hole passing through the fourth insulating layer 323, the third insulating layer 322, and the second buffer layer 321.

For example, if the subpixel SP is configured as in FIG. 2, the first thin film transistor TFT1 can be the first transistor T1 of FIG. 2, and the second thin film transistor TFT2 can be the driving transistor DT of FIG. 2.

The transistor portion can further include metal layers MP1 and MP2. The metal layers MP1 and MP2 included in the transistor portion can comprise a first metal layer MP1 and a second metal layer MP2. For example, the first metal layer MP1 can be disposed between the lower buffer layer 311a and the upper buffer layer 311b included in the first buffer layer 311, but the embodiments of the present disclosure are not limited thereto. The second metal layer MP2 can include the same first gate metal as the first gate electrode E1a of the first thin film transistor TFT1 and can be disposed within the first gate metal layer, but the embodiments of the present disclosure are not limited thereto. The first metal layer MP1 can be a first metal pattern, and the second metal layer MP2 can be a second metal pattern, but the embodiments of the present disclosure are not limited thereto.

Each of the first metal layer MP1 and the second metal layer MP2 can be disposed in the display area DA or the non-display area NDA.

Referring to FIG. 11, the transistor portion can further include a first shield pattern BSM1 disposed on the substrate 111. In this case, the first buffer layer 311 can be disposed on the first shield pattern BSM1 and a portion of the substrate 111 exposed by the first shield pattern BSM1. The first shield pattern BSM1 can overlap with the first active layer ACT1 of the first thin film transistor TFT1. The first shield pattern BSM1 can be disposed under the first active layer ACT1 of the first thin film transistor TFT1. For example, the first shield pattern BSM1 can be disposed between the substrate 111 and the first buffer layer 311, or can be disposed between the lower buffer layer 311a and the upper buffer layer 311b.

The transistor portion can further include a second shield pattern BSM2 disposed on the substrate 111. The second shield pattern BSM2 can overlap with the second active layer ACT2 of the second thin film transistor TFT2. The second shield pattern BSM2 can be disposed under the second active layer ACT2 of the second thin film transistor TFT2. For example, the second shield pattern BSM2 can be disposed in a metal layer between the second insulating layer 313 and the second buffer layer 321. The second shield pattern BSM2 can be disposed in the same metal layer as the second capacitor electrode CAPE2, but the embodiments of the present disclosure are not limited thereto. For another example, the second shield pattern BSM2 can be disposed in the same first gate metal layer as the first gate electrode E1a of the first thin film transistor TFT1.

The transistor portion can further include a common driving signal layer CVP to which a common driving signal is applied. The common driving signal layer CVP can be disposed in a display area DA or a non-display area NDA. The common driving signal layer CVP can overlap with dam DAM, without being limited thereto.

For example, the common driving signal applied to the common driving signal layer CVP can be referred to as a power signal, and can include at least one of a driving voltage VDD and a base voltage VSS. The driving voltage VDD can also be referred to as a high-potential driving voltage (e.g., high-potential power voltage or high-potential voltage), and the base voltage VSS can also be referred to as a low-potential driving voltage (e.g., low-potential power voltage or low-potential voltage).

The planarization layer 330 can be disposed on the first thin film transistor TFT1 and the second thin film transistor TFT2, and can be disposed under the light emitting device ED. The planarization layer 330 can be an organic insulating layer including an organic insulating material.

As one example, the planarization layer 330 can be formed of one or more materials of acrylic resin, epoxy resin, phenolic resin, polyamides resin, unsaturated polyesters resin, polyphenylene resin, polyphenylene sulfides resin, and benzocyclobutene, but embodiments are not limited thereto.

For example, the planarization layer 330 can be composed of one layer. As another example, the planarization layer 330 can include two layers. The planarization layer 330 can include a first planarization layer 331 and a second planarization layer 332. As another example, the planarization layer 330 can include three or more layers. Embodiments of the present disclosure are not limited thereto.

For example, the first planarization layer 331 can be disposed on the first thin film transistor TFT1 and the second thin film transistor TFT2. For example, the first planarization layer 331 can be disposed while covering both the first thin film transistor TFT1 and the second thin film transistor TFT2. Referring to FIG. 11, the first planarization layer 331 can be disposed on the first source electrode E1b and the first drain electrode E1c of the first thin film transistor TFT1 and the second source electrode E2b and the second drain electrode E2c of the second thin film transistor TFT2.

A relay electrode RE can be disposed on the first planarization layer 331. The relay electrode RE can electrically connect the second source electrode E2b of the second thin film transistor TFT2 and the pixel electrode PE.

The relay electrode RE can be electrically connected to the second source electrode E2b of the second thin film transistor TFT2 through a hole passing through the first planarization layer 331. The second source electrode E2b of the second thin film transistor TFT2 can be electrically connected to the second capacitor electrode CAPE2 of the storage capacitor Cst.

The relay electrode RE can be disposed in a second metal layer on the first planarization layer 331, and can include a second metal. The second metal and the second metal layer can be referred to as a second source-drain metal and a second source-drain metal layer.

The second planarization layer 332 can be disposed on the relay electrode RE.

The light emitting device portion can be disposed on the second planarization layer 332. The light emitting device ED can be formed on the second planarization layer 332. The light emitting device ED can include a pixel electrode PE, an emission layer EL, and a common electrode CE. The emission layer EL can be disposed between the pixel electrode PE and the common electrode CE. An emission area of the light emitting device ED can be formed in an area where the pixel electrode PE, the emission layer EL and the common electrode CE overlap and contact each other.

The pixel electrode PE can be disposed on a second planarization layer 332. The pixel electrode PE can be electrically connected to the relay electrode RE through a hole passing through the second planarization layer 332.

A bank 334 can be disposed on the pixel electrode PE. An opening of the bank 334 can expose a part of the pixel electrode PE to form an emission area. The opening of the bank 334 can overlap with a part of the pixel electrode PE.

For example, the bank 334 can be composed of a material including a black pigment, or an organic material such as a benzocyclobutene resin, a polyimide resin, an acrylic resin, or a photosensitive polymer, but the embodiments of the present disclosure are not limited thereto. Alternatively, the bank 334 can include an inorganic insulating material such as silicon nitride, aluminum nitride, zirconium nitride, titanium nitride, hafnium nitride, tantalum nitride, silicon oxide, aluminum oxide, or titanium oxide, etc. If the bank 334 is composed of a material including a black pigment or a black dye, the bank can be a black bank. If the bank 334 is composed of a material including a black pigment or a black dye, the bank can block light from the outside or light reflected from the outside, so that there can further improve the brightness or the luminance of the display device 100.

The emission layer EL of the light emitting device ED can be disposed on a part of the pixel electrode PE and the bank 334. The common electrode CE can be disposed on the emission layer EL.

The encapsulation portion can be disposed on the light emitting device portion, and can be located on the common electrode CE. The encapsulation portion can include an encapsulation layer 200 formed on the common electrode CE.

The encapsulation layer 200 can prevent or reduce moisture or oxygen from penetrating into the light emitting device ED. For example, the encapsulation layer 200 can prevent or reduce moisture or oxygen from penetrating into an organic material included in the emission layer EL of the light emitting device ED. The encapsulation layer 200 can be composed of a single layer or a multilayer, but the embodiments of the present disclosure are not limited thereto.

For example, the encapsulation layer 200 can include a first encapsulation layer 341, a second encapsulation layer 342, and a third encapsulation layer 343, but embodiments of the present disclosure are not limited thereto. For example, the first encapsulation layer 341 and the third encapsulation layer 343 can include inorganic encapsulation layers, and the second encapsulation layer 342 can include an organic encapsulation layer, but embodiments of the present disclosure are not limited thereto.

The inorganic encapsulating layers 341 and 343 can include an inorganic insulating material. For example, the inorganic encapsulating layers 341 and 343 can include an inorganic insulating material capable of low-temperature deposition, such as silicon nitride (SiN), silicon oxide (SiO), silicon oxynitride (SiON) and aluminum oxide (Al₂O₃), without being limited thereto. The organic encapsulation layer 342 can include an organic insulating material, such as acrylic resin, epoxy resin, polyimide, polyethylene and silicon oxycarbide (SiOC), without being limited thereto.

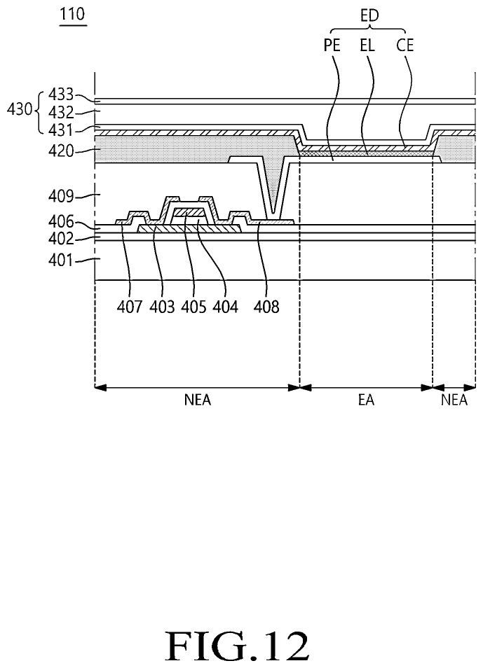

FIG. 12 illustrates another implementation example of a display panel 110 according to example embodiments of the present disclosure. Specifically, FIG. 12 illustrates a cross-sectional view of a display panel 110 according to the subpixel circuit of FIG. 3.

Referring to FIG. 12, the display panel 110 can include at least one thin film transistor disposed on a substrate 301 in a display area DA and a light emitting device ED disposed on the thin film transistor.

The thin film transistor can include an active layer 403, a gate electrode 405, a first electrode 407, and a second electrode 408.

For example, the thin film transistor can be a driving transistor DT of FIG. 3, and the first electrode 407 can be one of a drain electrode and a source electrode of the driving transistor DT, and the second electrode 408 can be one of a source electrode and a drain electrode of the driving transistor DT.

The light emitting device ED can include a pixel electrode PE, an emission layer EL, and a common electrode CE. The emission layer EL can be disposed between the pixel electrode PE and the common electrode CE. For example, the pixel electrode PE can be an anode electrode AND, and the common electrode CE can be a cathode electrode CAT.

A buffer layer 402 can be disposed on the substrate 401, and an active layer 403 and an interlayer insulating film 406 can be disposed on the buffer layer 402.

A gate insulating film 404 can be disposed on the active layer 403, and a gate electrode 405 of a thin film transistor can be disposed on the gate insulating film 404, and the insulating film 404 can be disposed on the active layer 403.

The first electrode 407 and the second electrode 408 of a thin film transistor can be disposed spaced apart from each other on the interlayer insulating film 406.

Each of the first electrode 407 and the second electrode 408 can be connected to a portion of the upper surface of the active layer 403 through a contact hole provided in the interlayer insulating film 406, and a planarization layer 409 can be provided on the substrate 401 on which the first electrode 407 and the second electrode 408 are provided.

The pixel electrode PE of a light emitting device ED can be provided on a portion of the upper surface of the planarization layer 409, and the pixel electrode PE can be electrically connected to the second electrode 408 of the thin film transistor through a contact hole provided in the planarization layer 409.

The emission layer EL can be disposed on the pixel electrode PE, and a common electrode CE can be disposed on the emission layer EL. The emission layer EL can be disposed on a portion of the pixel electrode PE.

A bank 420 can be disposed on the planarization layer 409, and can be disposed to surround the pixel electrode PE and the emission layer EL of the light emitting device ED.

The bank 420 can define an emission EA and a non-emission area NEA within the display area DA. For example, an area in the display area DA where the bank 420 is disposed can be a non-emission area NEA, and an area in the display area DA where the bank 420 is not disposed can be an emission area EA.

An encapsulation layer 430 can be disposed on the common electrode CE, and the encapsulation layer 430 can include a first encapsulation layer 431 disposed on the common electrode CE, a second encapsulation layer 432 disposed on the first encapsulation layer 431, and a third encapsulation layer 433 disposed on the second encapsulation layer 432. For example, the common electrode CE can be disposed on the bank 420 and the emission layer EL exposed by the bank 420.

For example, the first and third encapsulation layers 431 and 433 can include an inorganic insulating material, and the second encapsulation layer 432 can include an organic insulating material, without being limited thereto.

The first and third encapsulation layers 431 and 433 including an inorganic insulating material can serve to prevent or reduce moisture and oxygen from penetrating, and the second encapsulation layer 432 including an organic insulating material can serve to delay the movement of a small amount of moisture and oxygen penetrating through the third encapsulation layer 433.

Embodiments of the present disclosure described above are briefly described as follows.

A display device according to example embodiments of the present disclosure can include a display panel on which a plurality of gate lines, a plurality of data lines, and a plurality of subpixels are disposed, a gate driving circuit for driving the plurality of gate lines, a data driving circuit for supplying a data voltage to the plurality of data lines, and a display controller for controlling the gate driving circuit and the data driving circuit.

The data driving circuit can generate second digital data of an n-th subpixel on which an overdriving processing has been performed from first digital data of the n-th subpixel, based on a difference between the first digital data of the n-th subpixel connected to an n-th gate line among the plurality of gate lines and second digital data of an (n−1)-th subpixel connected to an (n−1)-th gate line among the plurality of gate lines, and supply the data voltage based on the second digital data of the n-th subpixel.

The data voltage, which is an analog voltage for the second digital data of the n-th subpixel, can be output from the data driving circuit during a data writing period.

The data voltage can have an overdriving voltage during an overdriving period within the data writing period, and can have an analog voltage for the first digital data of the n-th subpixel during a period after the overdriving period within the data writing period.

The overdriving period can increase as a distance between the data driving circuit and the n-th subpixel increases.

A level of the overdriving voltage can increase as a distance between the data driving circuit and the n-th subpixel increases.

A distance between the data driving circuit and the (n−1)-th subpixel can be smaller than a distance between the data driving circuit and the n-th subpixel.

A length of an application period of the first digital data of the n-th subpixel and a length of an application period of the second digital data of the n-th subpixel can be identical to each other.

The data driving circuit can include a first latch circuit for storing the first digital data of the n-th subpixel based on a sampling signal corresponding to a data control signal applied from the display controller, a line buffer for storing the second digital data of the (n−1)-th subpixel, a data compensation circuit for updating the second digital data of the n-th subpixel to the line buffer based on a comparison result between the second digital data of the (n−1)-th subpixel stored in the line buffer and the first digital data of the n-th subpixel stored in the first latch circuit, and a second latch circuit for receiving the second digital data of the n-th subpixel from the line buffer and outputting the second digital data of the n-th subpixel in response to a data timing control signal.

The second digital data of the n−1-th subpixel can be digital data derived based on the comparison result between the first digital data of the n−1-th subpixel and the second digital data of an n−2-th subpixel.

The data compensation circuit can include a comparator for comparing the second digital data of the (n−1)-th subpixel stored in the line buffer with the first digital data of the n-th subpixel stored in the first latch circuit, and calculating a data transition value of the first digital data of the n-th subpixel as a comparison result, and an adder for updating the second digital data of the n-th subpixel in the line buffer based on information corresponding to the data transition value among a plurality of overdriving period information and a plurality of overdriving level information previously stored in a look-up table.

The adder can update the second digital data of the n-th subpixel in the line buffer by applying an overdriving voltage of a level corresponding to the data transition value to the first digital data of the n-th subpixel during an overdriving period of a length corresponding to the data transition value.

The data driving circuit can update the line buffer with the first digital data of the n-th subpixel to which the overdriving period is not applied, as the second digital data of the n-th subpixel, if the data transition value is less than a preset threshold value.

The data timing control signal can include at least one of a source output enable signal and a source control signal.

A length of an application period of the source control signal can be equal to a length of an overdriving period.

The source control signal can be a signal corresponding to the timing at which digital data stored in the second latch circuit is output.

The data driving circuit can further include a digital-to-analog conversion circuit for converting the second digital data of the n-th subpixel into the data voltage based on a gamma grayscale voltage, and an output amplifier circuit for amplifying the data voltage received from the digital-to-analog conversion circuit and outputting the amplified data voltage.

The data driving circuit can include a first data driving circuit disposed at a position corresponding to a first surface of the display panel and a second data driving circuit disposed at a position corresponding to a second surface of the display panel opposite the first surface. The display panel can include a first panel area adjacent to the first surface and a second panel area adjacent to the second surface. The first data driving circuit can supply the data voltage to the plurality of data lines located within the first panel area, and the second data driving circuit can supply the data voltage to the plurality of data lines located within the second panel area.

Each of the first data driving circuit and the second data driving circuit can be configured to perform overdriving compensation for the data voltage provided to each of the first panel area and the second panel area.

Each of the plurality of subpixels can include a driving transistor, a light emitting device connected to the driving transistor, a first node connected to the light emitting device, and at least one transistor connected to at least one of a gate node, a drain node and a source node of the driving transistor. At least one transistor provided in the (n−1)-th subpixel and at least one transistor provided in the n-th subpixel can be connected to the same gate control signal line.

A display device according to example embodiments of the present disclosure can include a display panel including a first panel area and a second panel area, in which a plurality of gate lines, a plurality of data lines, and a plurality of subpixels are disposed respectively, a gate driving circuit for driving the plurality of gate lines, a first data driving circuit for supplying a data voltage to the plurality of data lines provided in the first panel area, and a second data driving circuit for supplying a data voltage to the plurality of data lines provided in the second panel area

Each of the first data driving circuit and the second data driving circuit can generate second digital data of an n-th subpixel on which an overdriving processing has been performed from first digital data of the n-th subpixel, based on a difference between the first digital data of the n-th subpixel connected to an n-th gate line among the plurality of gate lines provided in each of the first panel area and the second panel area and second digital data of an (n−1)-th subpixel connected to an (n−1)-th gate line among the plurality of gate lines, and supply the data voltage based on the second digital data of the n-th subpixel.

A data driving circuit according to example embodiments of the present disclosure can include a first latch circuit for storing first digital data of an n-th subpixel connected to an n-th gate line among a plurality of gate lines disposed on a display panel according to a sampling signal, a line buffer for storing second digital data of an (n−1)-th subpixel connected to an (n−1)-th gate line among the plurality of gate lines, a data compensation circuit for comparing the first digital data of the n-th subpixel with the second digital data of the (n−1)-th subpixel to update second digital data of the n-th subpixel in the line buffer, a second latch circuit for receiving the second digital data of the n-th subpixel from the line buffer and outputting the second digital data of the n-th subpixel in response to a data timing control signal.

The data compensation circuit can generate the second digital data of the n-th subpixel by applying an overdriving voltage to the first digital data of the n-th subpixel for an overdriving period of a length determined based on a comparison result between the first digital data of the n-th subpixel and the second digital data of the (n−1)-th subpixel.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein can be applied to other embodiments and applications without departing from the technical idea and scope of the present disclosure. The above description and the accompanying drawings provide an example of the technical idea of the present disclosure for illustrative purposes only. For example, the disclosed embodiments are intended to illustrate the scope of the technical idea of the present disclosure.

What is claimed is:

1. A display device comprising:
a display panel including a plurality of gate lines, a plurality of data lines, and a plurality of subpixels;
a gate driving circuit configured to drive the plurality of gate lines;
a data driving circuit configured to supply a data voltage to the plurality of data lines; and
a display controller configured to control the gate driving circuit and the data driving circuit,
wherein the data driving circuit is configured to generate second digital data of an n-th subpixel on which an overdriving processing has been performed from first digital data of the n-th subpixel, based on a difference between the first digital data of the n-th subpixel connected to an n-th gate line among the plurality of gate lines and second digital data of a n−1-th subpixel connected to a n−1-th gate line among the plurality of gate lines, and supply the data voltage based on the second digital data of the n-th subpixel.

2. The display device of claim 1, wherein the data voltage, which is an analog voltage for the second digital data of the n-th subpixel, is output from the data driving circuit during a data writing period, and
wherein the data voltage has an overdriving voltage during an overdriving period within the data writing period, and has an analog voltage for the first digital data of the n-th subpixel during a period after the overdriving period within the data writing period.

3. The display device of claim 2, wherein the overdriving period increases as a distance between the data driving circuit and the n-th subpixel increases.

4. The display device of claim 2, wherein a level of the overdriving voltage increases as a distance between the data driving circuit and the n-th subpixel increases.

5. The display device of claim 1, wherein a distance between the data driving circuit and the n−1-th subpixel is smaller than a distance between the data driving circuit and the n-th subpixel.

6. The display device of claim 1, wherein a length of an application period of the first digital data of the n-th subpixel and a length of an application period of the second digital data of the n-th subpixel are identical to each other.

7. The display device of claim 1, wherein the data driving circuit comprises:
a first latch circuit configured to store the first digital data of the n-th subpixel based on a sampling signal corresponding to a data control signal applied from the display controller;
a line buffer configured to store the second digital data of the n−1-th subpixel;
a data compensation circuit configured to update the second digital data of the n-th subpixel to the line buffer based on a comparison result between the second digital data of the n−1-th subpixel stored in the line buffer and the first digital data of the n-th subpixel stored in the first latch circuit; and
a second latch circuit configured to receive the second digital data of the n-th subpixel from the line buffer and output the second digital data of the n-th subpixel in response to a data timing control signal.

8. The display device of claim 7, wherein the second digital data of the n−1-th subpixel is digital data is derived based on the comparison result between the first digital data of the n−1-th subpixel and the second digital data of an n−2-th subpixel.

9. The display device of claim 7, wherein the data compensation circuit comprises:
a comparator configured to compare the second digital data of the n−1-th subpixel stored in the line buffer with the first digital data of the n-th subpixel stored in the first latch circuit, and calculate a data transition value of the first digital data of the n-th subpixel as a comparison result; and
an adder configured to update the second digital data of the n-th subpixel in the line buffer based on information corresponding to the data transition value among a plurality of overdriving period information and a plurality of overdriving level information previously stored in a look-up table.

10. The display device of claim 9, wherein the adder updates the second digital data of the n-th subpixel in the line buffer by applying an overdriving voltage of a level corresponding to the data transition value to the first digital data of the n-th subpixel during an overdriving period of a length corresponding to the data transition value.

11. The display device of claim 9, wherein the data driving circuit updates the line buffer with the first digital data of the n-th subpixel to which the overdriving period is not applied, as the second digital data of the n-th subpixel, when the data transition value is less than a preset threshold value.

12. The display device of claim 7, wherein the data timing control signal includes at least one of a source output enable signal and a source control signal.

13. The display device of claim 12, wherein a length of an application period of the source control signal is equal to a length of an overdriving period.

14. The display device of claim 7, wherein the data driving circuit further includes:
a digital-to-analog conversion circuit configured to convert the second digital data of the n-th subpixel into the data voltage based on a gamma grayscale voltage; and
an output amplifier circuit configured to amplify the data voltage received from the digital-to-analog conversion circuit and outputting the amplified data voltage.

15. The display device of claim 1, wherein the data driving circuit includes a first data driving circuit disposed at a position corresponding to a first surface of the display panel and a second data driving circuit disposed at a position corresponding to a second surface of the display panel opposite the first surface,
wherein the display panel includes a first panel area adjacent to the first surface and a second panel area adjacent to the second surface,
wherein the first data driving circuit supplies the data voltage to the plurality of data lines located within the first panel area, and
wherein the second data driving circuit supplies the data voltage to the plurality of data lines located within the second panel area.

16. The display device of claim 15, wherein each of the first data driving circuit and the second data driving circuit is configured to perform overdriving compensation for the data voltage provided to each of the first panel area and the second panel area.

17. The display device of claim 1, wherein each of the plurality of subpixels includes a driving transistor, a light emitting device connected to the driving transistor, a first node connected to the light emitting device, and at least one transistor connected to at least one of a gate node, a drain node and a source node of the driving transistor, and
wherein at least one transistor provided in the n−1-th subpixel and at least one transistor provided in the n-th subpixel are connected to a same gate control signal line.

18. A display device comprising:
a display panel including a first panel area and a second panel area, in which a plurality of gate lines, a plurality of data lines, and a plurality of subpixels are disposed respectively;
a gate driving circuit configured to drive the plurality of gate lines;
a first data driving circuit configured to supply a data voltage to the plurality of data lines provided in the first panel area; and
a second data driving circuit configured to supply a data voltage to the plurality of data lines provided in the second panel area,
wherein each of the first data driving circuit and the second data driving circuit is configured to:
generate second digital data of an n-th subpixel on which an overdriving processing has been performed from first digital data of the n-th subpixel, based on a difference between the first digital data of the n-th subpixel connected to an n-th gate line among the plurality of gate lines provided in each of the first panel area and the second panel area and second digital data of a n−1-th subpixel connected to a n−1-th gate line among the plurality of gate lines, and
supply the data voltage based on the second digital data of the n-th subpixel.

19. A data driving circuit comprising:
a first latch circuit configured to store first digital data of an n-th subpixel connected to an n-th gate line among a plurality of gate lines disposed on a display panel according to a sampling signal;
a line buffer configured to store second digital data of an n−1-th subpixel connected to an n−1-th gate line among the plurality of gate lines;
a data compensation circuit configured to compare the first digital data of the n-th subpixel with the second digital data of the n−1-th subpixel to update second digital data of the n-th subpixel in the line buffer;
a second latch circuit configured to receive the second digital data of the n-th subpixel from the line buffer and output the second digital data of the n-th subpixel in response to a data timing control signal,
wherein the data compensation circuit is configured to generate the second digital data of the n-th subpixel by applying an overdriving voltage to the first digital data of the n-th subpixel for an overdriving period of a length determined based on a comparison result between the first digital data of the n-th subpixel and the second digital data of the n−1-th subpixel.
